(19) United States
(12) Patent Application Publication
(10) Pub. No.: US 2023/0203209 A1
(43) Pub. Date: Jun. 29, 2023

(54) NON-IONIC AND ANIONIC SURFACTANTS BASED ON TOCOPHEROL

(71) Applicant: BASF SE, Ludwigshafen (DE)

(72) Inventors: Christian Hubert Weidl, Ludwigshafen (DE); Markus Roesch, Ludwigshafen (DE); Juergen Tropsch, Ludwigshafen (DE); Sebastian Mirtschin, Ludwigshafen (DE); Alexandra Wiedemann, Ludwigshafen (DE); Hans-Christian Raths, Düsseldorf-Holthausen (DE); Bernd Schneider, Ludwigshafen (DE)

(21) Appl. No.: 17/928,338

(22) PCT Filed: Jun. 2, 2021
(86) PCT No.: PCT/EP2021/064762

§ 371 Date: Nov. 29, 2022

(30) Foreign Application Priority Data
Jun. 5, 2020 (EP) 20178524.3

(51) Int. Cl. C08F 2/26; C08F 220/18; C08K 5/1545; C11D 1/83

(52) U.S. Cl. CPC C08F 2/26; C08F 220/1804; C08K 5/1545; C11D 1/83

(57) ABSTRACT

The presently claimed invention relates to the use of at least one compound of general formula (I) as an emulsifier or a stabilizer. The presently claimed invention further relates to the use of at least one compound of general formula (I) as an emulsifier or stabilizer in a polymerization reaction, preferably an emulsion polymerization. The presently claimed invention also relates to a method of emulsifying and/or stabilizing or dispersing liquids or solids in emulsion polymerization using at least one compound of general formula (I). Further, the presently claimed invention relates to a cleaning composition comprising at least one compound of general formula (I) and at least one additive.

### FIELD OF THE INVENTION

The presently claimed invention relates to the use of at least one compound of general formula (I) as an emulsifier or a stabilizer. The presently claimed invention further relates to the use of at least one compound of general formula (I) as an emulsifier or stabilizer in a polymerization reaction, preferably an emulsion polymerization. The presently claimed invention also relates to a method of emulsifying and/or stabilizing or dispersing liquids or solids in emulsion polymerization using at least one compound of general formula (I). Further, the presently claimed invention relates to a cleaning composition comprising at least one compound of general formula (I) and at least one additive.

### BACKGROUND OF THE INVENTION

Surfactants are widely used as an emulsifier in an emulsion polymerization process. In particular, alkyl phenols-based surfactants were generally considered standard. But alkyl phenols have an endocrinic effect. Hence, alkyl phenols and their derivatives have been replaced since quite some time due to their ecotoxicological profile by alkyl phenol ethoxylates (APE).

Alkyl phenol ethoxylates (APE) are non-ionic surfactants containing alkyl chains that are bound to a phenyl ring and a chain of repeating ethoxylate units. They are subject to increasing environmental regulation aimed at reducing their consumption. APEs do not exhibit the high levels of toxicity, estrogenic activity or environmental persistence associated with alkyl phenol (AP). However, in the environment APEs degrade to alkyl phenols (AP) and, thus, the release of APEs to the environment ultimately leads to the introduction of more highly toxic and persistent AP residues. APs are known to bioaccumulate and express estrogenic properties. The Environmental Protection Agency (EPA) has proposed to add an alkylphenol ethoxylates (APEs) category to the list of toxic chemicals.

Accordingly, it is an object of the presently claimed invention to provide surfactants that are a replacement for APEO, that are at least as good as an APEO surfactant in emulsifying/dispersing organic substances, that have less or no ecotoxicological concerns and that are environmentally friendly.

### SUMMARY OF THE INVENTION

Surprisingly, it was found that certain non-ionic and anionic surfactants based on tocopherol exhibit surface active properties such as lowering the surface tension of water and exhibiting a critical micelle concentration (CMC) and therefore act as efficient emulsifying and stabilizing agents.

Thus, in one aspect, the presently claimed invention is directed to the use of at least one compound of general formula (I) as an emulsifier

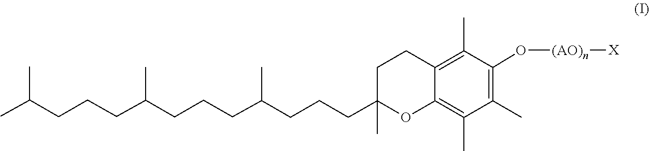

wherein
AO is identical or different and selected from CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O,
n is an integer in the range from 1 to 100,
X is selected from H, SO₃M, PO₃MH or PO₃M₂, and
M is selected from H, alkali metal, ammonium and alkanolamine cation.

In another aspect, the presently claimed invention is directed to a method of emulsion polymerization comprising the steps of
(A) charging into a reactor a reaction mixture comprising:
   (i) at least one monomer having an ethylenically unsaturated double bond,
   (ii) at least one compound of general formula (I), and
   (iii) at least one polymerization initiator;
(B) maintaining the reaction mixture of step (A) in the reactor at a temperature in the range of ≥20° C. to ≤105° C. for a time period in the range of ≥30 minutes to ≤12 hours.

In another aspect, the presently claimed invention is directed to a mixture comprising
(i) at least one monomer having an ethylenically unsaturated double bond selected from the group consisting of acrylic monomers, vinyl aromatic hydrocarbons and vinyl, allyl and methallyl esters of saturated aliphatic C₂-C₂₄ monocarboxylic acids,
(ii) at least one compound of general formula (I) as described above, and
(iii) water.

In another aspect, the presently claimed invention is directed to a mixture comprising
(i) at least one compound of general formula (I) as described above,
(ii) a polymer P, wherein the polymer P comprises at least one monomer selected from the group consisting of acrylic monomers, vinyl aromatic hydrocarbons and vinyl, allyl and methallyl esters of saturated aliphatic C₂-C₂₄ monocarboxylic acids, in polymerized form, and
(iii) water.

In another aspect, the presently claimed invention is directed to a compound of general formula (Ia),

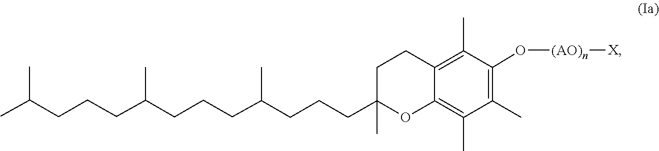

wherein
AO is CH₂—CH₂—O,
n is an integer in the range from 0 to 100,
X is selected from SO₃M, PO₃HM and PO₃M₂, and
M is selected from H, alkali metal, ammonium and alkanolamine cation.

In still another aspect, the presently claimed invention is directed to a compound of general formula (Ib),

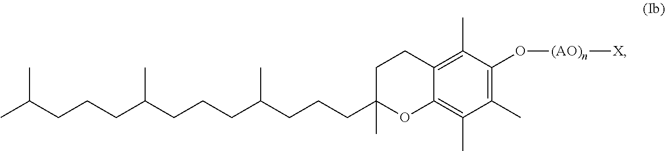

wherein
AO is identical or different and selected from the group consisting of CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O,
n is an integer in the range from 1 to 100,
X is selected from H, SO₃M, PO₃HM and PO₃M₂, and
M is selected from H, alkali metal, ammonium and alkanolamine cation.

In another aspect, the presently claimed invention is directed to a mixture comprising
(a1) the at least one compound of general formula (Ia) as defined above; and
(a2) the at least one compound of general formula (Ib) as defined above.

In another aspect, the presently claimed invention is directed to a cleaning composition comprising
(I) at least one compound of general formula (I), (Ia) or (Ib) as defined above; and
(II) at least one additive.

In another aspect, the presently claimed invention is directed to a process for preparation of a compound of general formula (I) comprising the steps of
a. alkoxylation of compound of formula (II) with an alkoxylating agent,

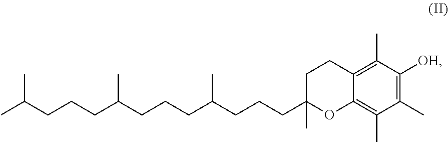 [SMILES: Cc1c(C)c2c(c(C)c1O)CCC(C)(CCCC(C)CCCC(C)CCCC(C)C)O2]

to obtain an alkoxylated product, and
b. sulfation of the alkoxylated product obtained in step a. with a sulfating agent.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “a preferred embodiment” means that a particular feature, structure or characteristic described in connection with the embodiment is included in at least one embodiment of the presently claimed invention. Thus, appearances of the phrases “in one embodiment” or “in a preferred embodiment” or “in another embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well i.e. a range of 1 to 10 implies that both 1 and 10 are included in the range. For the avoidance of doubt, the applicant shall be entitled to any equivalents according to the applicable law.

Certain terms are first defined so that this disclosure can be more readily understood. Unless defined otherwise, all technical and scientific terms used herein have the same meaning as commonly understood by one of ordinary skill in the art to which embodiments of the invention pertain.

In an aspect, the presently claimed invention is directed to use of the at least one compound of general formula (I) as an emulsifier,

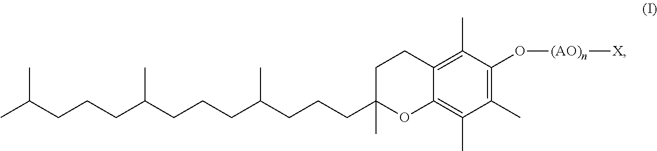

wherein
AO is identical or different and is selected from CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O,
n is an integer in the range of [symbol] 1 to [symbol] 100,
X is selected from H, SO₃M, PO₃MH and PO₃M₂, and
M is selected from H, alkali metal, ammonium and alkanolamine cation.

Alkanolamine cation is a cation of monoethanolamine, diethanolamine, triethanolamine, 1,3-monopropanolamine, 1,3-dipropanolamine, 1,3-tripropanolamine, monoisopropanolamine, diisopropanolamine, triisopropanolamine, trimethylolaminomethane, 2-amino-1-butanol, 2-amino-2-methyl-1,3-propanediol and 2-amino-2-ethyl-1,3-propanediol. p In a preferred embodiment, (AO) is selected from the group consisting of CH₂—CH₂—O, CH(CH₃)—CH₂—O and CH₂—CH(CH₃)—O.

In a preferred embodiment, n is an integer in the range of [symbol] 1 to [symbol] 99 or [symbol] 1 to [symbol] 98 or [symbol] 1 to [symbol] 97 or [symbol] 1 to [symbol] 96 or [symbol] 1 to 95 or [symbol] 1 to [symbol] 94 or [symbol] 1 to [symbol] 93 or [symbol] 1 to [symbol] 92 or [symbol] 1 to [symbol] 91 or [symbol] 1 to [symbol] 90 or [symbol] 1 to [symbol] 89 or [symbol] 1 to [symbol] 88 or [symbol] 1 to [symbol] 87 or [symbol] 1 to [symbol] 86 or [symbol] 1 to [symbol] 85 or [symbol] 1 to [symbol] 84 or [symbol] 1 to [symbol] 83 or [symbol] 1 to [symbol] 82 or [symbol] 1 to [symbol] 81 or [symbol] 1 to [symbol] 80 or [symbol] 1 to [symbol] 79 or [symbol] 1 to [symbol] 78 or [symbol] 1 to [symbol] 77 or [symbol] 1 to [symbol] 76 or [symbol] 1 to [symbol] 75 or [symbol] 1 to [symbol] 74 or [symbol] 1 to [symbol] 73 or [symbol] 1 to [symbol] 72 or [symbol] 1 to [symbol] 71 or [symbol] 1 to [symbol] 70 or [symbol] 1 to [symbol] 69 or [symbol] 1 to [symbol] 68 or [symbol] 1 to [symbol] 67 or [symbol] 1 to [symbol] 66 or [symbol] 1 to [symbol] 65 or [symbol] 1 to [symbol] 64 or [symbol] 1 to [symbol] 63 or [symbol] 1 to [symbol] 62 or [symbol] 1 to [symbol] 61 or [symbol] 1 to [symbol] 60 or [symbol] 1 to [symbol] 59 or [symbol] 1 to [symbol] 58 or [symbol] 1 to [symbol] 57 or [symbol] 1 to [symbol] 56 or [symbol] 1 to [symbol] 55 or [symbol] 1 to [symbol] 54 or [symbol] 1 to [symbol] 53 or [symbol] 1 to [symbol] 52 or [symbol] 1 to [symbol] 51 or [symbol] 1 to [symbol] 50 or [symbol] 1 to [symbol] 49 or [symbol] 1 to [symbol] 48 or [symbol] 1 to [symbol] 47 or [symbol] 1 to [symbol] 46 or [symbol] 1 to [symbol] 45 or [symbol] 1 to [symbol] 44 or [symbol] 1 to [symbol] 43 or [symbol] 1 to [symbol] 42 or [symbol] 1 to [symbol] 41 or [symbol] 1 to [symbol] 40 or [symbol] 1 to [symbol] 39 or [symbol] 1 to [symbol] 38 or [symbol] 1 to [symbol] 37 or [symbol] 1 to [symbol] 36 or [symbol] 1 to [symbol] 35 or [symbol] 1 to [symbol] 34 or [symbol] 1 to [symbol] 33 or [symbol] 1 to [symbol] 32 or [symbol] 1 to [symbol] 31 or [symbol] 1 to [symbol] 30 or [symbol] 1 to [symbol] 29 or [symbol] 1 to [symbol] 28 or [symbol] 1 to [symbol] 27 or [symbol] 1 to [symbol] 26 or [symbol] 1 to [symbol] 25, more preferably in the range of [symbol] 2 to [symbol] 99 or [symbol] 2 to [symbol] 98 or [symbol] 2 to [symbol] 97 or [symbol] 2 to [symbol] 96 or [symbol] 2 to [symbol] 95 or [symbol] 2 to [symbol] 94 or [symbol] 2 to [symbol] 93 or [symbol] 2 to [symbol] 92 or [symbol] 2 to [symbol] 91 or [symbol] 2 to [symbol] 90 or [symbol] 2 to [symbol] 89 or [symbol] 2 to [symbol] 88 or [symbol] 2 to [symbol] 87 or [symbol] 2 to [symbol] 86 or [symbol] 2 to [symbol] 85 or [symbol] 2 to [symbol] 84 or [symbol] 2 to [symbol] 83 or [symbol] 2 to [symbol] 82 or [symbol] 2 to [symbol] 81 or [symbol] 2 to [symbol] 80 or [symbol] 2 to [symbol] 79 or [symbol] 2 to [symbol] 78 or [symbol] 2 to [symbol] 77 or [symbol] 2 to [symbol] 76 or [symbol] 2 to [symbol] 75 or [symbol] 2 to [symbol] 74 or [symbol] 2 to [symbol] 73 or [symbol] 2 to [symbol] 72 or [symbol] 2 to [symbol] 71 or [symbol] 2 to [symbol] 70 or [symbol] 2 to [symbol] 69 or [symbol] 2 to [symbol] 68 or [symbol] 2 to [symbol] 67 or [symbol] 2 to [symbol] 66 or [symbol] 2 to [symbol] 65 or [symbol] 2 to [symbol] 64 or [symbol] 2 to [symbol] 63 or [symbol] 2 to [symbol] 62 or [symbol] 2 to [symbol] 61 or [symbol] 2 to [symbol] 60 or [symbol] 2 to [symbol] 59 or [symbol] 2 to [symbol] 58 or [symbol] 2 to [symbol] 57 or [symbol] 2 to [symbol] 56 or [symbol] 2 to [symbol] 55 or [symbol] 2 to [symbol] 54 or [symbol] 2 to [symbol] 53 or [symbol] 2 to [symbol] 52 or [symbol] 2 to [symbol] 51 or [symbol] 2 to [symbol] 50 or [symbol] 2 to [symbol] 49 or [symbol] 2 to [symbol] 48 or [symbol] 2 to [symbol] 47 or [symbol] 2 to [symbol] 46 or [symbol] 2 to [symbol] 45 or [symbol] 2 to [symbol] 44 or [symbol] 2 to [symbol] 43 or [symbol] 2 to [symbol] 42 or [symbol] 2 to [symbol] 41 or [symbol] 2 to [symbol] 40 or [symbol] 2 to [symbol] 39 or [symbol] 2 to [symbol] 38 or [symbol] 2 to [symbol] 37 or [symbol] 2 to [symbol] 36 or [symbol] 2 to [symbol] 35 or [symbol] 2 to [symbol] 34 or [symbol] 2 to [symbol] 33 or [symbol] 2 to [symbol] 32 or [symbol] 2 to [symbol] 31 or [symbol] 2 to [symbol] 30 or [symbol] 2 to [symbol] 29 or [symbol] 2 to [symbol] 28 or [symbol] 2 to [symbol] 27 or [symbol] 2 to [symbol] 26 or [symbol] 2 to [symbol] 25, even more preferably in the range of [symbol] 3 to [symbol] 99 or [symbol] 3 to [symbol] 98 or [symbol] 3 to [symbol] 97 or [symbol] 3 to [symbol] 96 or [symbol] 3 to [symbol] 95 or [symbol] 3 to [symbol] 94 or [symbol] 3 to [symbol] 93 or [symbol] 3 to [symbol] 92 or [symbol] 3 to [symbol] 91 or [symbol] 3 to [symbol] 90 or [symbol] 3 to [symbol] 89 or [symbol] 3 to [symbol] 88 or [symbol] 3 to [symbol] 87 or [symbol] 3 to [symbol] 86 or [symbol] 3 to [symbol] 85 or [symbol] 3 to [symbol] 84 or [symbol] 3 to [symbol] 83 or [symbol] 3 to [symbol] 82 or [symbol] 3 to [symbol] 81 or [symbol] 3 to [symbol] 80 or [symbol] 3 to [symbol] 79 or [symbol] 3 to [symbol] 78 or [symbol] 3 to [symbol] 77 or [symbol] 3 to [symbol] 76 or [symbol] 3 to [symbol] 75 or [symbol] 3 to [symbol] 74 or [symbol] 3 to [symbol] 73 or [symbol] 3 to [symbol] 72 or [symbol] 3 to [symbol] 71 or [symbol] 3 to [symbol] 70 or [symbol] 3 to [symbol] 69 or [symbol] 3 to [symbol] 68 or [symbol] 3 to [symbol] 67 or [symbol] 3 to [symbol] 66 or [symbol] 3 to [symbol] 65 or [symbol] 3 to [symbol] 64 or [symbol] 3 to [symbol] 63 or [symbol] 3 to [symbol] 62 or [symbol] 3 to [symbol] 61 or [symbol] 3 to [symbol] 60 or [symbol] 3 to [symbol] 59 or [symbol] 3 to [symbol] 58 or [symbol] 3 to [symbol] 57 or [symbol] 3 to [symbol] 56 or [symbol] 3 to [symbol] 55 or [symbol] 3 to [symbol] 54 or [symbol] 3 to [symbol] 53 or [symbol] 3 to [symbol] 52 or [symbol] 3 to [symbol] 51 or [symbol] 3 to [symbol] 50 or [symbol] 3 to [symbol] 49 or [symbol] 3 to [symbol] 48 or [symbol] 3 to [symbol] 47 or [symbol] 3 to [symbol] 46 or [symbol] 3 to [symbol] 45 or [symbol] 3 to [symbol] 44 or [symbol] 3 to [symbol] 43 or [symbol] 3 to [symbol] 42 or [symbol] 3 to [symbol] 41 or [symbol] 3 to [symbol] 40 or [symbol] 3 to [symbol] 39 or [symbol] 3 to [symbol] 38 or [symbol] 3 to [symbol] 37 or [symbol] 3 to [symbol] 36 or [symbol] 3 to [symbol] 35 or [symbol] 3 to [symbol] 34 or [symbol] 3 to [symbol] 33 or [symbol] 3 to [symbol] 32 or [symbol] 3 to [symbol] 31 or [symbol] 3 to [symbol] 30 or [symbol] 3 to [symbol] 29 or [symbol] 3 to [symbol] 28 or [symbol] 3 to [symbol] 27 or [symbol] 3 to [symbol] 26 or [symbol] 3 to [symbol] 25 or [symbol] 4 to [symbol] 99 or [symbol] 4 to [symbol] 98 or [symbol] 4 to [symbol] 97 or [symbol] 4 to [symbol] 96 or [symbol] 4 to [symbol] 95 or [symbol] 4 to [symbol] 94 or [symbol] 4 to [symbol] 93 or [symbol] 4 to [symbol] 92 or [symbol] 4 to [symbol] 91 or [symbol] 4 to [symbol] 90 or [symbol] 4 to [symbol] 89 or [symbol] 4 to [symbol] 88 or [symbol] 4 to [symbol] 87 or [symbol] 4 to [symbol] 86 or [symbol] 4 to [symbol] 85 or [symbol] 4 to [symbol] 84 or [symbol] 4 to [symbol] 83 or [symbol] 4 to [symbol] 82 or [symbol] 4 to [symbol] 81 or [symbol] 4 to [symbol] 80 or [symbol] 4 to [symbol] 79 or [symbol] 4 to [symbol] 78 or [symbol] 4 to [symbol] 77 or [symbol] 4 to [symbol] 76 or [symbol] 4 to [symbol] 75 or [symbol] 4 to [symbol] 74 or [symbol] 4 to [symbol] 73 or [symbol] 4 to [symbol] 72 or [symbol] 4 to [symbol] 71 or [symbol] 4 to [symbol] 70 or [symbol] 4 to [symbol] 69 or [symbol] 4 to [symbol] 68 or [symbol] 4 to [symbol] 67 or [symbol] 4 to [symbol] 66 or [symbol] 4 to [symbol] 65 or [symbol] 4 to [symbol] 64 or [symbol] 4 to [symbol] 63 or [symbol] 4 to [symbol] 62 or [symbol] 4 to [symbol] 61 or [symbol] 4 to [symbol] 60 or [symbol] 4 to [symbol] 59 or [symbol] 4 to [symbol] 58 or [symbol] 4 to [symbol] 57 or [symbol] 4 to [symbol] 56 or [symbol] 4 to [symbol] 55 or [symbol] 4 to [symbol] 54 or [symbol] 4 to [symbol] 53 or [symbol] 4 to [symbol] 52 or [symbol] 4 to [symbol] 51 or [symbol] 4 to [symbol] 50 or [symbol] 4 to [symbol] 49 or [symbol] 4 to [symbol] 48 or [symbol] 4 to [symbol] 47 or [symbol] 4 to [symbol] 46 or [symbol] 4 to [symbol] 45 or [symbol] 4 to [symbol] 44 or [symbol] 4 to [symbol] 43 or [symbol] 4 to [symbol] 42 or [symbol] 4 to [symbol] 41 or [symbol] 4 to [symbol] 40 or [symbol] 4 to [symbol] 39 or [symbol] 4 to [symbol] 38 or [symbol] 4to [symbol] 37 or [symbol] 4 to [symbol] 36 or [symbol] 4 to [symbol] 35 or [symbol] 4 to [symbol] 34 or [symbol] 4 to [symbol] 33 or [symbol] 4 to [symbol] 32 or [symbol] 4 to [symbol] 31 or [symbol] 4 to [symbol] 30 or [symbol] 4 to [symbol] 29 or [symbol] 4 to [symbol] 28 or [symbol] 4 to [symbol] 27 or [symbol] 4 to [symbol] 26 or [symbol] 4 to [symbol] 25 and most preferably in the range of [symbol] 5 to [symbol] 99 or [symbol] 5 to [symbol] 98 or [symbol] 5 to [symbol] 97 or [symbol] 5 to [symbol] 96 or [symbol] 5 to [symbol] 95 or [symbol] 5 to [symbol] 94 or [symbol] 5 to [symbol] 93 or [symbol] 5 to [symbol] 92 or [symbol] 5 to [symbol] 91 or [symbol] 5 to [symbol] 90 or [symbol] 5 to [symbol] 89 or [symbol] 5 to [symbol] 88 or [symbol] 5 to [symbol] 87 or [symbol] 5 to [symbol] 86 or [symbol] 5 to [symbol] 85 or [symbol] 5 to [symbol] 84 or [symbol] 5 to [symbol] 83 or [symbol] 5 to [symbol] 82 or [symbol] 5 to [symbol] 81 or [symbol] 5 to [symbol] 80 or [symbol] 5 to [symbol] 79 or [symbol] 5 to [symbol] 78 or [symbol] 5 to [symbol] 77 or [symbol] 5 to [symbol] 76 or [symbol] 5 to [symbol] 75 or [symbol] 5 to [symbol] 74 or [symbol] 5 to [symbol] 73 or [symbol] 5 to [symbol] 72 or [symbol] 5 to [symbol] 71 or [symbol] 5 to [symbol] 70 or [symbol] 5 to [symbol] 69 or [symbol] 5 to [symbol] 68 or [symbol] 5 to [symbol] 67 or [symbol] 5 to [symbol] 66 or [symbol] 5 to [symbol] 65 or [symbol] 5 to [symbol] 64 or [symbol] 5 to [symbol] 63 or [symbol] 5 to [symbol] 62 or [symbol] 5 to [symbol] 61 or [symbol] 5 to [symbol] 60 or [symbol] 5 to [symbol] 59 or z,55 5 to [symbol] 58 or z,55 5 to [symbol] 57 or z,55 5 to [symbol] 56 or z,55 5 to [symbol] 55 or z,55 5 to [symbol] 54 or z,55 5 to [symbol] 53 or z,55 5 to [symbol] 52 or z,55 5 to [symbol] 51 or z,55 5 to [symbol] 50 or z,55 5 to [symbol] 49 or z,55 5 to [symbol] 48 or z,55 5 to [symbol] 47 or z,55 5 to [symbol] 46 or z,55 5 to [symbol] 45 or z,55 5 to [symbol] 44 or z,55 5 to [symbol] 43 or z,55 5 to [symbol] 42 or z,55 5 to [symbol] 41 or z,55 5 to [symbol] 40 or z,55 5 to [symbol] 39 or z,55 5 to [symbol] 38 or z,55 5 to [symbol] 37 or z,55 5 to [symbol] 36 or z,55 5 to [symbol] 35 or z,55 5 to [symbol] 34 or z,55 5 to [symbol] 33 or z,55 5 to [symbol] 32 or z,55 5 to [symbol] 31 or z,55 5 to [symbol] 30 or z,55 5 to [symbol] 29 or z,55 5 to [symbol] 28 or z,55 5 to [symbol] 27 or z,55 5 to [symbol] 26 or z,55 5 to [symbol] 25 or z,55 6 to [symbol] 99 or z,55 6 to [symbol] 98 or z,55 6 to [symbol] 97 or z,55 6 to [symbol] 96 or z,55 6 to [symbol] 95 or z,55 6 to [symbol] 94 or z,55 6 to [symbol] 93 or z,55 6 to [symbol] 92 or z,55 6 to [symbol] 91 or z,55 6 to [symbol] 90 or z,55 6 to [symbol] 89 or z,55 6 to [symbol] 88 or z,55 6 to [symbol] 87 or z,55 6 to [symbol] 86 or z,55 6 to [symbol] 85 or z,55 6 to [symbol] 84 or z,55 6 to [symbol] 83 or z,55 6 to [symbol] 82 or z,55 6 to [symbol] 81 or z,55 6 to [symbol] 80 or z,55 6 to [symbol] 79 or z,55 6 to [symbol] 78 or z,55 6 to [symbol] 77 or z,55 6 to [symbol] 76 or z,55 6 to [symbol] 75 or z,55 6 to [symbol] 74 or z,55 6 to [symbol] 73 or z,55 6 to [symbol] 72 or z,55 6 to [symbol] 71 or z,55 6 to [symbol] 70 or z,55 6 to [symbol] 69 or z,55 6 to [symbol] 68 or z,55 6 to [symbol] 67 or z,55 6 to [symbol] 66 or z,55 6 to [symbol] 65 or z,55 6 to [symbol] 64 or z,55 6 to [symbol] 63 or z,55 6 to [symbol] 62 or z,55 6 to [symbol] 61 or z,55 6 to [symbol] 60 or z,55 6 to [symbol] 59 or z,55 6 to [symbol] 58 or z,55 6 to [symbol] 57 or z,55 6 to [symbol] 56 or z,55 6 to [symbol] 55 or z,55 6 to [symbol] 54 or z,55 6 to [symbol] 53 or z,55 6 to [symbol] 52 or z,55 6 to [symbol] 51 or z,55 6 to [symbol] 50 or z,55 6 to [symbol] 49 or z,55 6 to [symbol] 48 or z,55 6 to [symbol] 47 or z,55 6 to [symbol] 46 or z,55 6 to [symbol] 45 or z,55 6 to [symbol] 44 or z,55 6 to [symbol] 43 or z,55 6 to [symbol] 42 or z,55 6 to [symbol] 41 or z,55 6 to [symbol] 40 or z,55 6 to [symbol] 39 or z,55 6 to [symbol] 38 or z,55 6 to [symbol] 37 or z,55 6 to [symbol] 36 or z,55 6 to [symbol] 35 or z,55 6 to [symbol] 34 or z,55 6 to [symbol] 33 or z,55 6 to [symbol] 32 or z,55 6 to [symbol] 31 or z,55 6 to [symbol] 30 or z,55 6 to [symbol] 29 or z,55 6 to [symbol] 28 or z,55 6 to [symbol] 27 or z,55 6 to [symbol] 26 or z,55 6 to [symbol] 25.

In a preferred embodiment, M is selected from H, sodium, potassium and ammonium.

In a preferred embodiment, X is selected from H, SO₃Na, SO₃H, SO₃K, PO₃H₂, PO₃HNa, PO₃Na₂, PO₃HK and PO₃K₂.

In a preferred embodiment, AO identical or different and is selected from CH₂—CH₂—O, CH(CH₃)—CH₂—O and CH₂—CH(CH₃)—O, n is an integer in the range from ≥1 to ≤100, X is selected from H, SO₃M, PO₃MH and PO₃M₂, and M is selected from H, alkali metal, ammonium and alkanolamine cation.

In another preferred embodiment, AO is identical or different and is selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O, n is an integer in the range from ≥1 to ≤30, X is selected from H, SO₃M, PO₃MH and PO₃M₂, and M is selected from H, alkali metal, ammonium and alkanolamine cation.

In another preferred embodiment, AO is identical or different and is selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O, n is an integer in the range from ≥1 to ≤100, X is selected from H and SO₃M, and M is selected from H, alkali metal, ammonium and alkanolamine cation.

In another preferred embodiment, AO is identical or different and selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O, n is an integer in the range from ≥1 to ≤100, X is selected from H, PO₃MH and PO₃M₂, and M is selected from H, alkali metal, ammonium and alkanolamine cation.

In another preferred embodiment, AO is identical or different and selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O, n is an integer in the range from ≥1 to ≤100, X is selected from H, SO₃M, PO₃MH and PO₃M₂, and M is selected from H and alkali metal.

In another preferred embodiment, AO is identical or different and selected from the group consisting of CH₂—CH₂—O, CH(CH₃)—CH₂—O, and CH₂—CH(CH₃)—O, n is an integer in the range from ≥1 to ≤30, X is selected from H and SO₃M, and M is selected from H and alkali metal.

In an embodiment, the at least one compound of general formula (I) is used in a polymerization reaction.

In another preferred embodiment, the polymerization reaction is an emulsion polymerization.

In another aspect, the presently claimed invention is directed to a method of emulsion polymerization comprising the steps of
(A) charging into a reactor a reaction mixture comprising:
   (I) at least one monomer having an ethylenically unsaturated double bond,
   (II) at least one compound of general formula (I), and
   (III) at least one polymerization initiator; and
(B) maintaining the reaction mixture of step (A) in the reactor at a temperature in the range of ≥20° C. to ≤105° C. for a time period in the range of 30 minutes to 12 hours.

In another embodiment of the presently claimed invention, the method of emulsion polymerization comprises the steps of
(A) charging into a reactor a reaction mixture comprising:
   (I) at least one monomer having an ethylenically unsaturated double bond,
   (II) at least one compound of general formula (I), and
   (III) at least one polymerization initiator;
(B) maintaining the reaction mixture of step (A) in the reactor at a temperature in the range of ≥20° C. to ≤105° C. for a time period in the range of ≥30 minutes to ≤12 hours; and
(C) terminating of the reaction mixture of step (B).

The emulsion polymerization can be a batch process (batchwise), a semi continuous or fully continuous process, such as a feed process.

Suitable reactors include, but are not limited to, continuous stirred tank reactors (CSTRs), tube reactors, loop reactors, extruder reactors, or any reactor suitable for a continuous operation.

A form of CSTR, is a tank reactor provided with cooling coils and/or cooling jackets. The cooling coils and/or the cooling jackets have to be sufficient to remove any heat of the polymerization not taken up by raising the temperature of the continuously charged monomer composition to maintain a preselected temperature for polymerization therein. Such a CSTR may be provided with at least one, and usually more, agitators to provide a well-mixed reaction zone. Such CSTR may be operated at varying filling levels from 20 to 100% full (liquid full reactor LFR). In one embodiment the reactor is more than 50% full, but less than 100% full. In another embodiment the reactor is 100% liquid full.

In a preferred embodiment, the temperature in step (B) is in the range of ≥40° C. to ≤105° C. or ≥40° C. to ≤100° C. or ≥40° C. to ≤95° C. or ≥40° C. to ≤85° C., more preferably in the range of ≥50° C. to ≤105° C. or ≥50° C. to ≤100° C. or ≥50° C. to ≤95° C. or ≥50° C. to ≤85° C., even more preferably in the range of ≥60° C. to ≤105° C. or ≥60° C. to ≤100° C. or ≥60° C. to ≤95° C. or ≥60° C. to ≤90° C.

The most favourable temperature chosen is dependent on the decomposition characteristics of the initiator used or of the initiators used.

The pressure conditions are generally not critical and, for example, pressures in the range from atmospheric pressure to 10 bar are suitable.

In a preferred embodiment, the time period of the emulsion polymerization is in the range from ≥1 hour to ≤10 hours or ≥1 hour to ≤9 hours or ≥1 hour to ≤8 hours or ≥1 hour to ≤7 hours or ≥1 hour to ≤6 hours, more preferably in the range of ≥2 hours to ≤10 hours or ≥2 hours to ≤9 hours or ≥2 hours to ≤8 hours or ≥2 hours to ≤7 hours or ≥2 hours to ≤6 hours or ≥2 hours to ≤5 hours.

The steps (A), (B) and (C) can preferably be carried out in the presence of an inert gas, such as nitrogen or argon.

In an embodiment, the reaction mixture of the process of the presently claimed invention comprises at least one solvent.

Monomer having an Ethylenically Unsaturated Double Bond

The at least one monomer having an ethylenically unsaturated double bond is selected from the group consisting of
acrylic monomers;
vinyl aromatic hydrocarbons; and
vinyl, allyl, and methallyl esters of saturated aliphatic C₂-C₂₄ monocarboxylic acids.

In a preferred embodiment of the presently claimed invention, the at least one monomer having an ethylenically unsaturated double bond is an acrylic monomer.

In another preferred embodiment of the presently claimed invention, the acrylic monomer is a (meth)acrylic monomer.

As used herein, “(meth)acrylic monomer” refers to acrylic acid or methacrylic acid, esters of acrylic or methacrylic acid, salts, amides, and other suitable derivatives of acrylic or methacrylic acid and mixtures thereof. Examples of suitable acrylic monomers include, without limitation, the following methacrylate esters: methyl (meth)acrylate, ethyl (meth)acrylate, n-propyl (meth)acrylate, n-butyl (meth)acrylate, isopropyl (meth)acrylate, isobutyl (meth)acrylate, n-amyl (meth)acrylate, n-hexyl (meth)acrylate, isoamyl (meth)acrylate, 2-hydroxyethyl (meth)acrylate, 2-hydroxypropyl (meth)acrylate, N,N-dimethylaminoethyl (meth)acrylate, N,N-diethylaminoethyl (meth)acrylate, t-butylaminoethyl (meth)acrylate, trifluoroethyl (meth)acrylate, glycidyl (meth)acrylate, benzyl (meth)acrylate, allyl (meth)acrylate, 2-n-butoxyethyl (meth)acrylate, 2-chloroethyl (meth)acrylate, sec-butyl-(meth)acrylate, tert-butyl (meth)acrylate, 2-ethylbutyl (meth)acrylate, cinnamyl (meth)acrylate, crotyl (meth)acrylate, cyclohexyl (meth)acrylate, cyclopentyl (meth)acrylate, 2-ethoxyethyl (meth)acrylate, furfuryl (meth)acrylate, hexafluoroisopropyl (meth)acrylate, methallyl (meth)acrylate, 3-methoxybutyl (meth)acrylate, 2-methoxybutyl (meth)acrylate, 2-nitro-2-methylpropyl (meth)acrylate, n-octyl(meth)acrylate, 2-ethylhexyl (meth)acrylate, 2-phenoxyethyl (meth)acrylate, 2-phenylethyl (meth)acrylate, phenyl(meth)acrylate, propargyl (meth)acrylate, tetrahydrofurfuryl (meth)acrylate and tetrahydropyranyl (meth)acrylate. Example of suitable acrylate esters include, without limitation, methyl acrylate, ethyl acrylate, n-propyl acrylate, isopropyl acrylate, n-butyl acrylate and n-decyl acrylate.

Examples of other suitable acrylic monomers include, without limitation, methacrylic acid derivatives such as: methacrylic acid and its salts, methacrylonitrile, methacrylamide, N-methylmethacrylamide, N-ethylmethacrylamide, N, Ndiethylmethacrylamide, N,N-dimethylmethacrylamide, N-phenylmethacrylamide and methacrolein. Examples of acrylic acid derivatives include, without limitation, acrylic acid and its salts, acrylonitrile, acrylamide, methyl α-chloroacrylate, methyl 2-cyanoacrylate, N-ethylacrylamide, N,N-diethylacrylamide and acrolein.

Preferably, the at least one acrylic monomer is selected from the group consisting of ethyl acrylate, methyl (meth)acrylate, butyl(meth)acrylate, 2-ethylhexyl(meth)acrylate, hydroxyethyl(meth)acrylate and acrylic acid.

More preferably, the (meth)acrylic monomer is selected from the group consisting of methyl (meth)acrylate, butyl(meth)acrylate, n-butyl acrylate, and acrylic acid.

In a preferred embodiment of the presently claimed invention, the vinyl aromatic hydrocarbon is selected from the group consisting of styrene, vinyltoluene, tert-butylstyrene and α-methylstyrene. More preferably, the vinyl aromatic hydrocarbon is styrene.

In a preferred embodiment, the at least one monomer having an ethylenically unsaturated double bond is selected from the group consisting of vinyl, allyl and methallyl esters of saturated aliphatic C₂-C₂₄ monocarboxylic acids.

In a preferred embodiment, the at least one monomer having an ethylenically unsaturated double bond is a vinyl ester of a saturated aliphatic C₂-C₂₄ monocarboxylic acid.

In another preferred embodiment, the vinyl ester of a saturated aliphatic C₂-C₂₄ monocarboxylic acid is selected from the group consisting of vinyl acetate, vinyl propionate, vinyl butyrate, vinyl pivalate, vinyl hexanoate, vinyl-2-ethylhexanoate, vinyl laurate and vinyl stearate.

In a preferred embodiment, the amount of the at least one monomer having an ethylenically unsaturated double bond is in the range of 35% to 80% by weight, based on the total weight of the reaction mixture.

Polymerization Initiator

The emulsion polymerization is affected using at least one initiator. The at least one polymerization initiator suitable for carrying out the process according to the presently claimed invention may thermally decompose into radicals in a first order reaction.

In a preferred embodiment, the at least one initiator is an inorganic free radical initiator.

In a preferred embodiment, the inorganic free radical initiator is selected from the group consisting of ammonium persulfate, potassium persulfate, sodium persulfate, potassium peroxy dicarbonate, potassium peroxy diphosphate and mixtures thereof.

The at least one initiator can be selected from the group consisting of peroxides or systems containing at least one peroxide, such as redox initiators containing at least one peroxide. Examples of suitable peroxides are alkali metal peroxodisulfates, such as, for example, sodium peroxodisulfate or ammonium peroxodisulfate, hydrogen peroxide, organic peroxides, such as diacetyl peroxide, di-tert-butyl peroxide, diamyl peroxide, dioctanoyl peroxide, didecanoyl peroxide, dilauryl peroxide, dibenzoyl peroxide, bis(o-toluyl) peroxide, succinyl peroxide, tert-butyl peracetate, tert-butyl permaleate, tert-butyl perisobutyrate, tert-butyl perpivalate, tert-butyl peroctanoate, tert-butyl pemeodecanoate, tert-butyl perbenzoate, di-tertbutyl peroxide, tertbutyl hydroperoxide, cumyl hydroperoxide, tert-butyl peroxy-2-ethylhexanoate and diisopropyl peroxydicarbamate. Azo compounds, such as, for example, azobisisobutyronitrile, azobis(2-amidopropane) dihydrochloride and 2,2′-azobis(2-methylbutyronitrile) are also suitable. Redox initiators are likewise suitable, for example comprising peroxides or an oxidizable sulfur compound. Examples are combinations of at least one Fe(II) compound such as FeSO₄ and at least one peroxide such as H₂O₂, combinations of sodium persulfate and sodium metabisulfite, combinations of organic hydroperoxides and sodium metabisulfite, and combinations of tertiary amines and dibenzoyl peroxide.

The amount of polymerization initiator depends upon the conditions of the reaction and may be adjusted accordingly.

In a preferred embodiment, the at least one polymerization initiator is present in an amount in the range of ≥0.1% to ≤5%, preferably in the range of ≥0.1% to ≤4.5% or ≥0.1% to ≤4%, more preferably in the range of ≥0.1% to ≤5% or ≥0.1% to ≤4.5% or ≥0.1% to ≤4.0%, and most preferably in the range of ≥0.2% to ≤4.5% or ≥0.2% to ≤4.0% or ≥0.2% to ≤3.5% or ≥0.2% to ≤3.0% by weight, in each case based on the total weight of the reaction mixture.

In a preferred embodiment, the step (C) is carried out with a terminating compound selected from the group consisting of sodium bisulfite and sodium metabisulfite.

Solvent

In a preferred embodiment, the reaction mixture of the process of the presently claimed invention comprises at least one solvent.

The at least one solvent may be fed into the reactor together with the at least one monomer having an ethylenically unsaturated double bond, i.e. the at least one solvent and the at least one monomer having an ethylenically unsaturated double bond are fed in one single feed, or it may be fed into the reactor separately, i.e. the at least one solvent and the at least one monomer having an unsaturated double bond are fed in two feeds.

In a preferred embodiment, the at least one solvent is selected from the group comprising of water, xylene, toluene, ethyl benzene, light naphtha, heavy naphtha, acetone, methylethylketone, methylamylketone, methyl iso-butylketone, N-methylpyrrolidone, isopropanol, propylene glycol monomethyl ether acetate, acetic acid, propyl acetate, dipropylene glycol methyl ether acetate, propylene glycol diacetate, dipropylene glycol dimethyl ether, ethyl 3-ethoxy propionate and iso-parrafin.

In a preferred embodiment, the at least one solvent is water.

The at least one solvent is present in an amount in the range of ≥15% to ≤60% or ≥15% to ≤59% or ≥15% to ≤58% or ≥15% to ≤57% or ≥15% to ≤56% or ≥15% to ≤55% or ≥15% to ≤54% or ≥15% to ≤53% or ≥15% to ≤52% or ≥15% to ≤51% or ≥15% to ≤50% or ≥15% to ≤49% or ≥15% to ≤48% or ≥15% to ≤47% or ≥15% to ≤46% or ≥15% to ≤45% or ≥15% to ≤44% or ≥15% to ≤43% or ≥15% to ≤42% or ≥15% to ≤41% or ≥15% to ≤40% or ≥15% to ≤39% or ≥15% to ≤38% or ≥15% to ≤37% or ≥15% to ≤36% or ≥15% to ≤35%, more preferably in the range of ≥20% to ≤60% or ≥20% to ≤59% or ≥20% to ≤58% or ≥20% to ≤57% or ≥20% to ≤56% or ≥20% to ≤55% or ≥20% to ≤54% or ≥20% to ≤53% or ≥20% to ≤52% or ≥20% to ≤51% or ≥20% to ≤50% or ≥20% to ≤49% or ≥20% to ≤48% or ≥20% to ≤47% or ≥20% to ≤46% or ≥20% to ≤45% or ≥20% to ≤44% or ≥20% to ≤43% or ≥20% to ≤42% or ≥20% to ≤41% or ≥20% to ≤40% or ≥20% to ≤39% or ≥20% to ≤38% or ≥20% to ≤37% or ≥20% to ≤36% or ≥20% to ≤35% by weight, in each case based on the total weight of the reaction mixture.

In an aspect, the presently claimed invention is directed to a mixture comprising
(i) at least one monomer having an ethylenically unsaturated double bond selected from the group consisting of acrylic monomers, vinyl aromatic hydrocarbons and vinyl, allyl and methallyl esters of saturated aliphatic C₂-C₂₄ monocarboxylic acids,
(ii) at least one compound of general formula (I) as described above, and
(iii) water.

In an embodiment, the at least one monomer is selected from the group consisting of acrylic acid, methacrylic acid, methyl (meth)acrylate, butyl(meth)acrylate, n-butyl acrylate, styrene, vinyltoluene, tert-butylstyrene and α-methylstyrene, vinyl acetate, vinyl propionate, vinyl butyrate, vinyl pivalate, vinyl hexanoate, vinyl-2-ethylhexanoate, vinyl laurate and vinyl stearate.

In another aspect, the presently claimed invention is directed to a mixture comprising
(i) at least one compound of general formula (I) as described above,
(ii) a polymer P, wherein the polymer P comprises at least one monomer selected from the group consisting of acrylic monomers, vinyl aromatic hydrocarbons and vinyl, allyl and methallyl esters of saturated aliphatic C₂-C₂₄ monocarboxylic acids, in polymerized form, and
(iii) water.

In an embodiment, the at least one monomer is selected from the group consisting of acrylic acid, methacrylic acid, methyl (meth)acrylate, butyl(meth)acrylate, n-butyl acrylate, styrene, vinyltoluene, tert-butylstyrene, α-methylstyrene, vinyl acetate, vinyl propionate, vinyl butyrate, vinyl pivalate, vinyl hexanoate, vinyl-2-ethylhexanoate, vinyl laurate and vinyl stearate.

In another aspect, the presently claimed invention is directed to a compound of general formula (Ia)

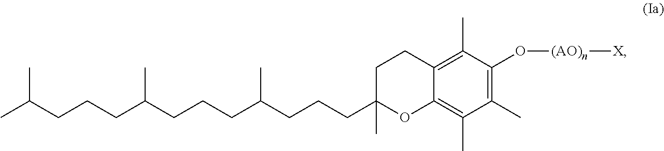

wherein
AO is CH₂—CH₂—O,
n is an integer in the range from 0 to 100,
X is selected from SO₃M, PO₃HM and PO₃M₂, and
M is selected from H, alkali metal, ammonium and alkanolamine cation.

In a preferred embodiment, M is selected from the group consisting of H, sodium, potassium and ammonium.

In an embodiment, the presently claimed invention is directed to the compound of general formula (I), wherein AO is CH₂—CH₂—O, n is an integer in the range of ≥1 to ≤100, X is selected from the group consisting of SO₃Na, SO₃H, SO₃K, PO₃H₂, PO₃HNa, PO₃Na₂, PO₃HK and PO₃K₂.

In an embodiment, the presently claimed invention is directed to the compound of general formula (I), wherein AO is CH₂—CH₂—O, n is an integer in the range of ≥2 to ≤100, X is selected from the group consisting of SO₃Na, SO₃H, SO₃K, PO₃H₂, PO₃HNa, PO₃Na₂, PO₃HK and PO₃K₂.

In an embodiment, the presently claimed invention is directed to the compound of general formula (I), wherein AO is CH₂—CH₂—O, n is an integer in the range of ≥5 to ≤100, X is selected from the group consisting of SO₃Na, SO₃H, SO₃K, PO₃H₂, PO₃HNa, PO₃Na₂, PO₃HK and PO₃K₂.

In an embodiment, the presently claimed invention is directed to the compound of general formula (I), wherein AO is CH₂—CH₂—O, n is an integer in the range of ≥5 to ≤50, X is selected from the group consisting of SO₃Na, SO₃H, SO₃K, PO₃H₂, PO₃HNa, PO₃Na₂, PO₃HK and PO₃K₂.

In another aspect, the presently claimed invention is directed to a compound of general formula (Ib)

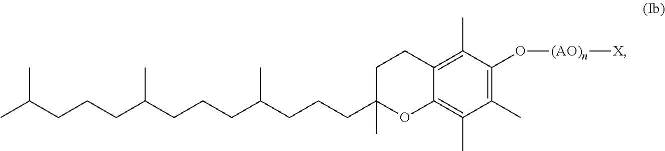

wherein
AO is identical or different and is selected from the group consisting of CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O,
n is an integer in the range from 1 to 100,
X is selected from H, SO₃M, PO₃HM and PO₃M₂, and
M is selected from H, alkali metal, ammonium and alkanolamine cation.

In a preferred embodiment, (AO) is selected from the group consisting of CH(CH₃)—CH₂—O and CH₂—CH(CH₃)—O.

In a preferred embodiment, M is selected from the group consisting of H, sodium, potassium and ammonium.

In another preferred embodiment, X is selected from the group consisting of H, SO₃Na, SO₃H, SO₃K, PO₃H₂, PO₃HNa, PO₃Na₂, PO₃HK or PO₃K₂.

In another embodiment, the presently claimed invention is directed to the compound of general formula (I), wherein AO is selected from the group consisting of CH(CH₃)—CH₂—O, CH₂—CH(CH₃)—O and mixture thereof, n is an integer in the range of 1 to 100, X is selected from the group consisting of H, SO₃Na, SO₃H, SO₃K, PO₃HNa, PO₃Na₂, PO₃HK and PO₃K₂.

In another aspect, the presently claimed invention is directed to a mixture comprising
(a1) the at least one compound of general formula (Ia) as defined above; and
(a2) the at least one compound of general formula (Ib) as defined above.

In another aspect, the presently claimed invention describes a cleaning composition comprising
(I) at least one compound of general formula (I) as defined in above embodiments; and
(II) at least one additive.

In an embodiment, the amount of the at least one compound of general formula (I) is in the range of from ≥0.1 to ≤99.0% by weight, based on the total weight of the composition.

In an embodiment, the cleaning composition is in solid or liquid form.

The term ‘solid’ refers to a composition which is generally in a shape-stable form at ambient temperature, for example a powder, particle, agglomerate, flake or granule. A solid may have varying degrees of shape stability and will substantially retain its shape under moderate stress, pressure or mere gravity.

“Liquid” as used herein means that a continuous phase or predominant part of the laundry detergent composition is liquid, and that the composition is which flows freely and is of constant volume at ambient temperature (i.e., suspended solids may be included). ‘Deformable’ herein denotes that the composition will flow on applying pressure or on gentle shaking. Gels are included in the definition of ‘liquid’ as used herein.

Additives

In an embodiment, the presently claimed invention further comprises at least one additive. The at least one additive is selected from the group consisting of solvents, surfactants, amine oxides, curing agents, dyes, fragrances, antimicrobial agents, thickening agents, anti-redeposition agents and fatty alcohols.

In an embodiment, the amount of the at least one additive is in the range of ≥1 to ≤99.0% by weight, based on the total weight of the composition.

Solvents

The cleaning composition according to the presently claimed invention may contain solvents. The solvents that may be used in the cleaning composition can be selected from the group consisting of monovalent or polyvalent alcohols, alkanolamines and glycol ethers. The solvents are selected from the group consisting of ethanol, n-propanol, isopropanol, ethylene glycol, butanediol, glycerol, diethylene glycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether or propylene glycol propyl ether, dipropylene glycol monomethyl ether, dipropylene glycolethyl ether, diisopropylene glycol monomethyl ether, diisopropylene glycol monoethyl ether, methoxytriglycol, ethoxytriglycol, butoxytriglycol, 1-butoxyethoxy-2-propanol, 3-methyl-3-methoxybutanol, propylene glycol tert-butyl ether and mixtures thereof.

Surfactants

The cleaning composition according to the presently claimed invention may contain at least one surfactant. The at least one surfactant used in the cleaning composition are different from the compound of general formula (I) of the presently claimed invention.

The at least one surfactant is selected from the group consisting of anionic, cationic, amphoteric, nonionic surfactants and mixtures thereof.

Suitable anionic surfactants are selected from the group consisting of salts of alkyl sulfate, alkyl ether sulfates, α-olefin sulfonates and linear alkyl benzene sulfonates.

The alkyl sulfates are compounds of the formula:

ROSO₃⁻M⁺

wherein
R is selected from linear or branched, unsubstituted C₆-C₂₂ alkyl, and
M is selected from alkali metal or ammonium cation.

For the purposes of the presently claimed invention, the term “C₆-C₂₂-alkyl” covers acyclic saturated hydrocarbon residues, which may be linear or branched and unsubstituted having 6 to 22 carbon atoms.

The alkyl sulfates are obtained by sulfating the higher alcohols (C₆-C₂₂ carbon atoms) produced from the glycerides of tallow, coconut oil, suitable vegetable oil or synthetic alcohols followed by neutralization with alkali hydroxide. Thus, the alkyl sulfates also contain reaction by-products such as free salt (for example sodium chloride is the free salt by product, when neutralization agent is sodium hydroxide), free fatty alcohol, salt of fatty alcohol. Therefore, the solid content of the alkyl sulfate will be different from the active content. Active content denotes ‘the amount of alkyl sulfate’ present in the composition, whereas the solid content denotes ‘a total of alkyl sulfate, fatty alcohol, salt of fatty alcohol and the free salt’ in the composition. ‘Free’ herein denotes that the salt is not bound to the fatty alcohol/alkyl sulfate by any kind of chemical bonding.

Alkyl ether sulfates are compounds of the formula

R′—O—(C₂H₄O)ₘ—SO₃M

wherein
R′ is selected from linear or branched, unsubstituted C₆-C₂₂ alkyl,
m is an integer in the range of 1 to 20, and
M is selected from alkali metal or ammonium cation.

The alkyl ether sulfates are produced by the ethoxylation of fatty alcohol and thus will generally be obtained in the form of mixtures comprising varying alkyl chain lengths and varying degrees of ethoxylation. Frequently such mixtures will inevitably also contain some non-ethoxylated alkyl sulfates.

α-Olefin sulfonates are generally produced by sulfonating α-olefin. The α-olefins, which are sulfonated to form the surfactants used in the compositions of the presently claimed invention, may contain from about 10 to 22 carbon atoms and preferably 12 to 18 carbon atoms. They may be derived from a variety of processes such as, for example, by wax cracking, ethylene built up or dehydration of the corresponding primary alcohol. Exemplary α-olefins are 1-decene, 1-unde-cene, 1-dodecene, 1-tridecene, 1-tetradecene, 1-pentadecene, 1-hexadecene, 1-heptadecene, 1-octadecene and the like and mixtures of the aforesaid. Sulfonation of these long chain olefins is typically carried out utilizing sulfur trioxide mixed with a diluent. After the sulfonation is completed, neutralization and hydrolysis of the acid mixture is carried out so that any by-product sultones which are formed are converted to the corresponding hydroxy-alkane sulfonates. Thus, as is well known in the art, the term α-olefin sulfonates as used herein includes not only the alkene sulfonate itself but also admixtures of the same that are formed as a result of the usual sulfonation neutralization, and hydrolysis procedure with substantial proportions of the corresponding water soluble hydroxyalkane sulfonates.

Linear alkyl benzene sulfonate (LABS) is produced by sulfonation of linear alkylbenzene (LAB) and subsequent neutralization of the corresponding sulfonic acid (HLAS). Linear alkylbenzene is synthesized by the alkylation of benzene with linear olefins. Traditional processes for alkylation of aromatics compounds use Friedel-Craft type catalysts, for example, hydrofluoric acid, aluminum trichloride and the like.

Anionic surfactant may also include alkylamide sulfates of formula

R₆CONHR₇OSO₃P

wherein
R₆ is C₂-C₂₂ alkyl,
R₇ is C₂-C₃ alkyl, and
P is a hydrogen atom or an alkali metal cation or ethoxylated (EO) and/or propoxylated (PO) derivatives thereof, containing on average from 0.5 to 60 EO and/or PO units.

Further anionic surfactants are, salts of C₈-C₂₄, saturated or unsaturated fatty acids, alkylglyceryl sulfonates, paraffin sulfonates, N-acyl N-alkyltaurates, alkylphosphates, isethionates, alkylsuccinamates, alkyl sulfosuccinates, sulfosuccinate monoesters or diesters, N-acyl sarcosinates, alkylglycoside sulfates, polyethoxycarboxylates, the cation being an alkali metal (sodium, potassium or lithium), a substituted or unsubstituted ammonium residue (methyl-, dimethyl-, trimethyl- or tetramethylammonium, dimethylpiperidinium, etc.) or an alkanolamine derivative (monoethanolamine, diethanolamine, triethanolamine, etc.) and alkyl or alkylaryl phosphate esters.

Cationic surfactants are a well-known group of surface-active compounds which have at least one active cationic (positive ion) constituent. As the cationic surfactant, quaternary ammonium hydroxides such as octyltrimethylammonium hydroxide, dodecyltrimethylammonium hydroxide, hexadecyltrimethylammonium hydroxide, octyldimethylbenzylammonium hydroxide, decyldimethylbenzylammonium hydroxide, didodecyldimethylammonium hydroxide, dioctadecyldimethylammonium hydroxide, beef tallow trimethylammonium hydroxide, and coconut oil trimethylammonium hydroxide, and their salts can be exemplified.

Examples of amphoteric surfactants comprise betaines, sulfobetaines and carboxylates and sulfonates of fatty acids and of imidazole, such as alkyldimethylbetaines, alkylamidopropyldimethylbetaines, alkyldimethylsulfobetaines or alkylamidopropyldimethylsulfobetaines, such as Mirataine CBS sold by the company Rhodia, and the products of condensation of fatty acids and of protein hydrolysates; alkylamphoacetates or alkylamphodiacetates, in which the alkyl group contains from 6 to 20 carbon atoms; amphoteric alkylpolyamine derivatives such as Amphionic XL® sold by Rhodia and Ampholac 7T/X® and Ampholac 7C/X® sold by Berol Nobel.

Among the nonionic surfactants which may be mentioned in particular are condensates of alkylene oxide, in particular of ethylene oxide, with alcohols, polyols, alkylphenols, fatty acid esters, fatty acid amides and fatty amines; oxide amines, sugar derivatives such as polyalkylglycosides or fatty acid esters of sugars, in particular sucrose monopalmitate; long-chain tertiary phosphine oxides; dialkyl sulfoxides; block copolymers of polyoxyethylene and of polyoxypropylene; polyalkoxylated sorbitan esters; fatty esters of sorbitan, poly(ethylene oxide) and fatty acid amides modified so as to give them a hydrophobic nature (for example fatty acid mono- and diethanolamides containing from 10 to 18 carbon atoms). Particularly, polyoxyalkylated (polyethoxyethylated, polyoxypropylated or polyoxybutylated) alkylphenols in which the alkyl substituent is C₆-C₁₂ and containing from 5 to 25 oxyalkylene units, glucosamides, glucamides and glycerolamides; polyoxyalkylated C₈-C₂₂ aliphatic alcohols containing from 1 to 25 oxyalkylene (oxyethylene, oxypropylene) units.

Additional examples of suitable surfactants are compounds generally used as surfactants denoted in Surface Active Agents, volume I by Schwartz and Perry, and Surface-Active Agents and Detergents, volume II by Schwartz, Perry and Berch.

Amine Oxides

The cleaning composition of the presently claimed invention may also comprise amine oxides. Amine oxides are tertiary amine oxides. In an embodiment, the amine oxides are selected from the group consisting of the coconut or tallow alkyl di-(lower alkyl) amine oxides, specific examples of which are dodecyldimethylamine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide and 3,6,9-trioctadecyldimethylamine oxide and 3-dodecoxy-2-hydroxypropyldi-(2-hydroxyethyl)amine oxide.

Curing Agents

The cleaning composition of the presently claimed invention may also comprise curing agents. In an embodiment, the curing agents are selected from the group consisting of polyether amines, cycloaliphatic amines and nitriles. Curing agents are known and commercially available, such as Baxxodur® EC 280, Baxxodur® EC 301, Baxxodur® EC 311, Baxxodur® EC 130, Baxxodur® EC 302, Baxxodur® EC 303 and Baxxodur® EC 310.

Dyes

The cleaning composition of the presently claimed invention may optionally comprise one or more dyes. The dye is used to colour the non-chlorinated aqueous cleaning composition. This might render the product more attractive to the consumer. Dyes that can be used in the cleaning composition include, but are not limited to, Nylosan® yellow N-7GL, Sanolin® brilliant flavine 8GZ, Sanolin® yellow BG, Vitasyn® quinoline yellow 70, Vitasyn® tartrazine X90, Puricolor® yellow AYE23, Basacid yellow 232, Vibracolor® yellow AYE17, Simacid® Eosine Y, Puricolor® red ARE27, Puricolor® red ARE14, Vibracolor® red ARE18, Vibracolor® red ARE52, Vibracolor® red SRE3, Basacid® red 316, Ponceau® SX, Iragon® blue DBL86, Sanolin® blue EHRL, Sanolin® turquoise blue FBL, Basacid® blue 750, Iragon® blue ABL80, Vitasyn® blue AE90, Basacid® blue755, Vitasyn® patentblue V 8501 and Vibracolor® green AGR25.

Fragrances

The cleaning composition of the presently claimed invention may optionally comprise one or more fragrances. Suitable fragrances are those derived from natural sources or are synthetic aromatic substances. Natural aromatic substances are, for example, extracts from blossom (lilies, lavender, roses, jasmine, neroli, ylang-ylang), from stems and leaves (geranium, patchouli, petitgrain), from fruit (aniseed, coriander, caraway, juniper), from fruit peel (bergamot, lemons, oranges), from roots (mace, angelica, celery, cardamom, costus, iris, calamus), from wood (pinewood, sandalwood, guaiacum wood, cedarwood, rose-wood), from herbs and grasses (tarragon, lemon grass, sage, thyme), from needles and twigs (spruce, pine, scots pine, mountain pine), from resins and balsams (galbanum, elemi, benzoin, myrrh, olibanum, opopanax). Typical synthetic aromatic substances are, for example, products of the ester, ether, aldehyde, ketone, alcohol or hydrocarbon type. Aromatic substance compounds of the ester type are, for example, benzyl acetate, phenoxyethyl isobutyrate, p-tert-butyl cyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include, for example, the linear alkanals having from 8 to 18 hydrocarbon atoms, citral, citronellal, citronellyl oxyacetaldehyde, cyclamen aldehyde, hydroxy citronellal, lilial and bourgeonal; the ketones include, for example, the ionones, isomethylionone and methyl cedryl ketone; the alcohols include, for example, anethol, citronellol, eugenol, isoeugenol, geraniol, linalool, phenyl ethyl alcohol and terpinol; and the hydrocarbons include mainly the terpenes and balsams. Ethereal oils of relatively low volatility, which are chiefly used as aroma components, are also suitable for fragrance, e.g. sage oil, camomile oil, clove oil, melissa oil, oil of cinnamon leaves, lime blossom oil, juniper berry oil, vetiver oil, olibanum oil, galbanum oil, labolanum oil and lavandin oil.

Anti-Microbial Agents

The cleaning composition of the presently claimed invention may optionally comprise one or more anti-microbial agents. Generally, these materials fall in specific classes including phenolics, halogen compounds, quaternary ammonium compounds, metal derivatives, amines, alkanol amines, nitro derivatives, anilides, organosulfur and sulfur-nitrogen compounds and miscellaneous compounds. The given antimicrobial agent depending on chemical composition and concentration may simply limit further proliferation of numbers of the microbe or may destroy all or a substantial proportion of the microbial population. The terms “microbes” and “microorganisms” typically refer primarily to bacteria and fungus microorganisms. Common antimicrobial agents that may be used include phenolic antimicrobials such as pentachlorophenol, orthophenylphenol; halogen containing antibacterial agents that may be used include sodium trichloroisocyanurate, sodium dichloroisocyanurate (anhydrous or dihydrate), iodine-poly(vinylpyrolidin-onen) complexes, bromine compounds such as 2-bromo-2-nitropropane-1,3-diol; quaternary antimicrobial agents such as benzalkonium chloride, cetylpyridiniumchloride; amines and nitro containing antimicrobial compositions such as hexahydro-1,3,5-tris(2-hydroxyethyl)-s-triazine, dithiocarbamates such as sodium dimethyldithiocarbamate, and a variety of other materials known in the art for their microbial properties. When an antimicrobial agent is incorporated into the composition, the composition of an antimicrobial agent can be present in the range of approximately 0-10000 ppm in cleaning solutions at use concentrations.

Thickening Agents

The cleaning compositions of the presently claimed invention may also comprise viscosity modifiers or thickeners for obtaining a desired viscosity of the laundry detergent composition. Suitable viscosity modifiers are polysaccharides, for e.g. xanthan gum, carboxymethylcellulose, organic clays (organically modified or unmodified), polycarboxylates and silicates. Some examples of additional thickeners include soluble organic or inorganic thickener material. Some examples of inorganic thickeners include clays, silicates and other well-known inorganic thickeners. Some examples of organic thickeners include thixotropic and non-thixotropic thickeners. In some embodiments, the thickeners have some substantial proportion of water solubility to promote easy removability. Examples of soluble organic thickeners are, but not limited to, carboxylated vinyl polymers such as polyacrylic acids and sodium salts thereof, ethoxylated cellulose, polyacrylamide thickeners, xanthan thickeners, guar gum, sodium alginate and algin by-products, hydroxy propyl cellulose, hydroxy ethyl cellulose and other similar aqueous thickeners that have some substantial proportion of water solubility.

Anti-Redeposition Agents

Antiredeposition agents are useful in the presently claimed invention to assist in reducing redepositing of the removed soil onto the surface being cleaned. Anti-redeposition agent(s) can provide their effect by becoming adsorbed irreversibly or reversibly to the soil particles or to the article surface, thereby the soil becomes better dispersed in the non-chlorinated aqueous cleaning compositions or the article is occupied with anti-redeposition agent(s) on those places the soil could redeposit. Examples of the anti-redeposition agent(s) that are known to be used in the cleaning compositions include, but are not limited to, carboxymethyl cellulose, polyester-PEG co-polymer and polyvinyl pyrrolidone based polymers.

Fatty Alcohol

The cleaning compositions of the presently claimed invention may also comprise at least one fatty alcohol. The at least one fatty alcohol is derived from vegetable oil. Preferred fatty alcohol have a carbon chain length in the range of 10 to 24. Tallows produce a fairly narrow range of alcohols, predominantly C₁₆-C₁₈. Higher alcohols (C₂₀-C₂₂) can be obtained from rapeseed oil or mustard seed oil. Midcut alcohols are obtained from coconut oil (C₁₂-C₁₄) or palm kernel oil (C₁₆-C₁₈). A preferred fatty alcohol is C₁₂-C₁₆ fatty alcohol.

In another aspect, the presently claimed invention describes a process for preparation of compound of general formula (I), comprising the steps of
a. alkoxylation of compound of formula (II) with an alkoxylating agent to obtain an alkoxylated product

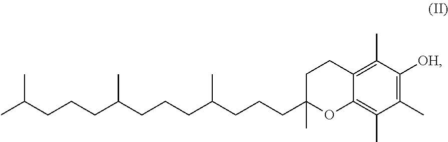 [SMILES: Cc1c(C)c2c(c(C)c1O)CCC(C)(CCCC(C)CCCC(C)CCCC(C)C)O2]

and
b. sulfation of the alkoxylated product obtained in step (a) with a sulfating agent to obtain sulfated alkoxylated product.

In an embodiment of the presently claimed invention, the process for preparation of compound of general formula (I) further comprising step c) of treatment with alkali metal hydroxide.

In a preferred embodiment of the presently claimed invention, the alkoxylating agent is selected from the group consisting of ethylene oxide, propylene oxide, butylene oxide and mixtures thereof.

In a preferred embodiment of the presently claimed invention, the sulfating agent is selected from the group consisting of chlorosulfonic acid and sulfur trioxide.

In an embodiment of the presently claimed invention, for preparation of general formula (I) in step (b) if instead of a sulfating agent, a phosphating agent is employed, the resulting compound of general formula (I) comprises a phosphate group.

In a preferred embodiment of the presently claimed invention, the phosphating agent is selected from the group consisting of phosphoric acid, phosphorus pentoxide (P₂O₅), tetraphosphoric acid and salts thereof.

When the compound of formula (II) is treated in step (a) with an alkoxylating agent, the resulting compound of general formula (I) are obtained wherein AO is identical or different and is selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O, n is an integer in the range of ≥1 to ≤100 and X is H. These compounds are classified as non-ionic surfactants.

The compounds of formula (II) when subjected to both step(a) and step (b), the resulting compound of general formula (I) are obtained wherein AO is identical or different and selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O, n is an integer in the range of ≥1 to ≤100, X is SO₃M, PO₃HM, or PO₃M₂ and M is H. When step (c) is performed, M is an alkali metal, ammonium or alkanolamine cation. These compounds are classified as anionic surfactants.

In a preferred embodiment of the presently claimed invention, the alkoxylation in step (a) is carried out at a temperature in the range of ≥50° C. to ≤160° C. for a time period in the range of ≥1 hour to ≤10 hours.

In a preferred embodiment of the presently claimed invention, the sulfation in step (b) is carried out at a temperature in the range of ≥40° C. to ≤80° C. for a time period in the range of ≥15 minutes to ≤3 hours.

In a preferred embodiment of the presently claimed invention, the molar ratio of the compound of formula (II) to the alkoxylating agent is in the range from 1:5 to 1:50, more preferably is in the range from 1:5 to 1:40, and most preferably is in the range from 1:5 to 1:35.

In a preferred embodiment of the presently claimed invention, the molar ratio of the alkoxylated product obtained in step (a) to the sulfating agent is in the range from 0.5:1 to 1.5:2, more preferably is in the range from 0.8:1.3 to 1:1.5.

The presently claimed invention offers one or more of following advantages:
1. The tocopherol-based compounds of general formula (I) are environment friendly surfactants compared to the APEO (alkylphenolethoxylates) surfactants.
2. Compound of the general formula (I) of the presently claimed invention are used as stabilizers in emulsion polymerization process.
3. Handling advantage in the production of compound of the general formula (I) since tocopherol used is in a liquid state at room temperature.

In the following, specific embodiments of the presently claimed invention are described:
1. Use of at least one compound of general formula (I) as an emulsifier

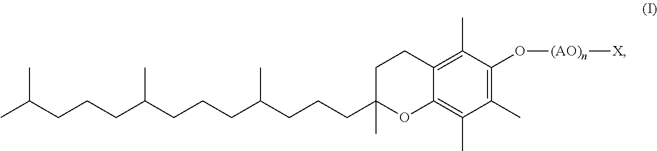

wherein
AO is identical or different and is selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O,
n is an integer in the range from ≥1 to ≤100,
X is selected from H, SO₃M, PO₃MH and PO₃M₂, and
M is selected from H, alkali metal, ammonium and alkanolamine cation.
2. The use according to claim 1, wherein the emulsifier is used in a polymerization reaction.
3. The use according to embodiment 2, wherein the polymerization reaction is an emulsion polymerization.
4. A method of emulsion polymerization comprising the steps of
   (A) charging into a reactor a reaction mixture comprising:
      (I) at least one monomer having an ethylenically unsaturated double bond,
      (II) at least one compound of general formula (I),

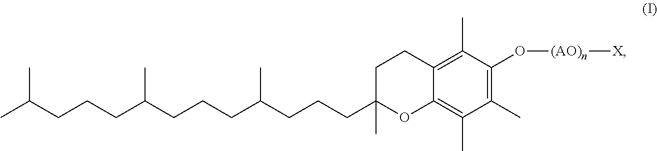

wherein
AO is identical or different and is selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O,
n is an integer in the range from ≥1 to ≤100,
X is selected from H, SO₃M, PO₃MH and PO₃M₂,
M is selected from H, alkali metal, ammonium and alkanolamine cation; and
   (III) at least one polymerization initiator;
(B) maintaining the reaction mixture of step (A) in the reactor at a temperature in the range of ≥20° C. to ≤105° C. for a time period in the range of ≥30 minutes to ≤12 hours.
5. The use or method according to one or more of embodiments 1 to 4, wherein AO is selected from the group consisting of CH₂—CH₂—O, CH(CH₃)—CH₂—O and CH₂—CH(CH₃)—O.
6. The method according to embodiment 4, further comprising step (C) of terminating of the reaction mixture of step (B).
7. The method according to embodiment 6, wherein the step (C) is carried out with a terminating compound selected from the group consisting of sodium bisulfite and sodium metabisulfite.
8. The method according to embodiment 4, wherein the at least one monomer having an ethylenically unsaturated double bond is selected from the group consisting of acrylic monomers, vinyl aromatic hydrocarbons and vinyl, allyl and methallyl esters of saturated aliphatic C₂-C₂₄ monocarboxylic acids.
9. The method according to embodiment 4, wherein the at least one polymerization initiator is an inorganic free radical initiator.
10. The method according to embodiment 9, wherein the inorganic free radical initiator is selected from the group consisting of ammonium persulfate, potassium persulfate, sodium persulfate, potassium peroxy dicarbonate and potassium peroxy diphosphate.
11. A mixture comprising
   (i) at least one monomer having an ethylenically unsaturated double bond selected from the group consisting of acrylic monomers, vinyl aromatic hydrocarbons and vinyl, allyl and methallyl esters of saturated aliphatic C₂-C₂₄ monocarboxylic acids,
   (ii) at least one compound of general formula (I) according to one or more of embodiments 1 to 10, and
   (iii) water.
12. A mixture comprising
   (i) at least one compound of general formula (I) according to one or more of embodiments 1 to 10,
   (ii) a polymer P, wherein the polymer P comprises at least one monomer selected from the group consisting of acrylic monomers, vinyl aromatic hydrocarbons and vinyl, allyl and methallyl esters of saturated aliphatic C₂-C₂₄ monocarboxylic acids, in polymerized form, and
   (iii) water.
13. The mixture comprising according the embodiments 11 or 12, wherein the at least one monomer is selected from the group consisting of acrylic acid, methacrylic acid, methyl (meth)acrylate, butyl(meth)acrylate, n-butyl acrylate, styrene, vinyltoluene, tert-butylstyrene, α-methylstyrene, vinyl acetate, vinyl propionate, vinyl butyrate, vinyl pivalate, vinyl hexanoate, vinyl-2-ethylhexanoate, vinyl laurate and vinyl stearate.
14. A compound of general formula (Ia)

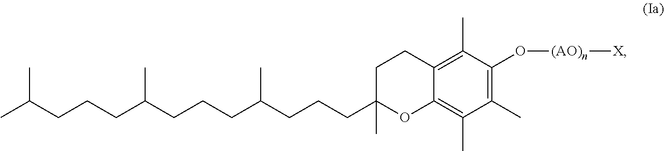

wherein
AO is CH₂—CH₂—O,
n is an integer in the range from ≥0 to ≤100,
X is selected from SO₃M, PO₃HM and PO₃M₂, and
M is selected from H, alkali metal, ammonium and alkanolamine cation.
15. The compound of general formula (Ia) according claim 14, wherein n is an integer in the range of ≥1 to ≤100.
16. A compound of general formula (Ib)

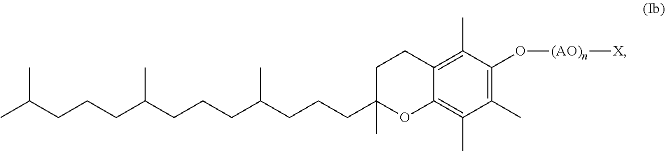

wherein
AO is identical or different and is selected from the group consisting of CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O,
n is an integer in the range from 1 to 100,
X is selected from H, SO₃M, PO₃HM and PO₃M₂, and
M is selected from H, alkali metal, ammonium and alkanolamine cation.
17. A mixture comprising
   (a1) the at least one compound of general formula (Ia) according to embodiments 14 or 15; and
   (a2) the at least one compound of general formula (Ib) according to embodiment 16.
18. A cleaning composition comprising
   (I) at least one compound of general formula (I), (Ia) or (Ib) as defined in embodiment 1 or according to embodiments 15 to 17; and
   (II) at least one additive.
19. The cleaning composition according to embodiment 18 which is in solid or liquid form.
20. The cleaning composition according to embodiment 18 and 19, wherein the at least one additive is selected from the group consisting of solvents, surfactants, amine oxides, curing agents, dyes, fragrances, antimicrobial agents, thickening agents, anti-redeposition agents and fatty alcohols.
21. A process for preparation of compound as defined in any one or more of embodiments 1 to 17, comprising the steps of
   a. alkoxylation of compound of formula (II) with an alkoxylating agent,

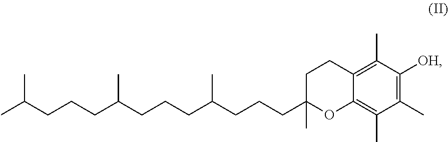 [SMILES: Cc1c(C)c2c(c(C)c1O)CCC(C)(CCCC(C)CCCC(C)CCCC(C)C)O2]

to obtain an alkoxylated product, and
b. sulfation of the alkoxylated product obtained in step a. with a sulfating agent.
22. The process according to embodiment 21, further comprising step c. of treatment with alkali metal hydroxide.
23. The process according to embodiment 21, further comprising phosphation of the alkoxylated product obtained in step a. with a phosphating agent.
24. The process according to embodiment 21, wherein the alkoxylating agent is selected from the group consisting of ethylene oxide, propylene oxide and mixtures thereof.
25. The process according to embodiment 21, wherein the sulfating agent is selected from the group consisting of chlorosulfonic acid and sulfur trioxide.
26. The process according to embodiment 23, wherein the phosphating agent is selected from the group consisting of phosphoric acid, phosphorus pentoxide (P₂O₅), tetraphosphoric acid and salts thereof.
27. The process according to embodiment 21, wherein a step a. is carried out at a temperature in the range of ≥50° C. to ≤160° C. for a time period in the range of≥1 hour to ≤10 hours.
28. The process according to embodiment 21, wherein step b. is carried out at a temperature in the range of ≥40° C. to ≤80° C. for a time period in the range of ≥15 minutes to ≤3 hours.
29. The process according to embodiment 21, wherein the molar ratio of the compound of formula (II) to the alkoxylating agent is in the range from 1:5 to 1:50.
30. The process according to embodiment 21, wherein the molar ratio of the alkoxylated product obtained in step a. to the sulfating agent is in the range from 0.5:1 to 1.5:2.

### EXAMPLES

Compounds

D,L-α-Tocopherol,

Ethylene oxide,

Propylene oxide

Disodium dihydrogen pyrophosphate,

Acetic acid

Styrene,

Butyl acrylate,

Methacrylic acid,

Sodium metabisulfite,

Sodium persulfate,

Potassium persulfate

Ammonia (aqueous solution)

Ethoxylated octyl phenol (25 EO) (comparative surfactant)

Ethoxylated octylphenol (25 EO), sulfate, Na-salt (comparative surfactant)

Analytical Methods for the Surfactants

Hydroxyl value was determined according to the method DIN 53 240,

Colour iodine was determined according to the method EN 1557, 23° C.,

Colour apha was determined according to the method EN 1557, 23° C.,

pH value was determined according to the method EN 1262,

Water content was determined according to the method EN 13267,

Dry matter was determined according to the method DIN 53 240,

Active matter of anionic surfactants was determined according to the Epton titration

Analytical Methods for the Polymer Dispersions:

Solid Content: Determined by drying about 5 g of polymer dispersion at 150° C. for 20 minutes using a Mettler Toledo Moisture Analyzer HR 83.

Viscosity: Determined at room temperature by using a Brookfield viscometer DV-II+ (RV spindle set) at 20 rpm.

Conversion: Calculated by dividing the measured solid content by the theoretical solid content.

Coagulum: Reported as dry coagulum, as the sum of the coagulum obtained by filtering the polymer dispersion using a 125-micrometer filter and the coagulum that is collected from the stirrer and reactor wall. The wet coagulum is dried in the Mettler Toledo Moisture Analyzer HR 83 at 130° C. until the weight is constant.

Particle size: Is reported as the d50 measured with a Beckman Coulter LS 13320 Laser Diffraction Particle Sizer Analyzer.

Visual evaluation: The polymer dispersion is casted on a glass plate with a 100-micrometer knife coater. After drying 24 hours at room temperature, the polymer film is evaluated visually and graded on a scale of 1 to 6, 1 is for the best and 6 is for the worst.

Water absorption: A polymer film (approx. 75 mm×35 mm×2 mm) is cast by drying the polymer dispersion in a teflon form for 48 hours at 50° C. The dried film is weighed and then submerged into deionized water at room temperature for 24 hours. Then the film weighed again after removing excess water. The weight increase due to absorption of water is reported in percentage.

Electrolyte stability: 6 electrolyte solutions are prepared and tested in this order: 1% NaCl, 10% NaCl, 1% CaCl₂, 10% CaCl₂, 1% Al₂(SO₄)₃, 10% Al₂(SO₄)₃. To check the electrolyte stability 10 ml of polymer dispersion is mixed with 10 ml of electrolyte solution. It is visually observed if the polymer dispersion coagulates after shaking of the mixture. The electrolyte concentration where the polymer dispersion is still stable (does not coagulate) is reported.

Shear stability: 50 g polymer emulsion is filled into a glass cylinder and put under shear stress using a high-speed stirrer (Company LatexMST, Model MK2 for synthetic rubber) at 14,000 rpm. The shear stress is applied for 30 minutes. If the emulsion coagulates before 30 minutes, the time at which the coagulation occurs is recorded. If the emulsion is stable for 30 minutes, it is filtered, and the filter residue is determined.

Freeze/Thaw stability: 30 g polymer emulsion are filled into a transparent plastic bottle. The sample is frozen at a certain temperature and thawed to room temperature again. This is called one cycle. At each temperature the sample has to survive 5 cycles. The temperatures used are −5° C., −10° C., −15° C., −20° C. The lowest temperature at which the sample survives 5 cycles is recorded.

Alkoxylation:

Equipment: 2.5 L Stainless steel reactor with propeller agitator, approved for at least 5.8 bar and vacuum. Controlled addition of ethylene oxide (EO)/propylene oxide (PO) is done through Bronk-host-Liqui-Flow.

### Example 1: Ethoxylated Tocopherol (Tocopherol+10 EO, Desalted)

D,L-α-Tocopherol (458.0g) and potassium hydroxide solution 44% (3.2 g) were charged into the reactor. The reactor was heated to 120° C. and evacuated to <20 mbar for at least 60 minutes before it was aerated with nitrogen to 2 bar and depressurized to 0.5 bar, followed by raising the temperature of the reactor to 140° C. Ethylene oxide dosing (468.7 g) was started above the temperature of 134° C. After the ethylene oxide dosing was finished a consecutive reaction for 60 minutes (at reaction temperature) took place. Then the reactor was cooled down to 95° C., depressurized and stripped at 100mbar for 30 minutes with nitrogen to obtain a product mixture containing ethoxylated tocopherol.

For the desalting, water (10.0g) was added to the product mixture and stirring was done for 10 minutes. Further, disodium dihydrogen pyrophosphate (7.3 g) was added to the product mixture and stirred for 30 minutes at 80° C. A sample was taken, pH determined (EN 1262, solution B) and when the pH was found to be <7.0, the reactor was heated up to 100° C. and evacuated to <100 mbar. When the temperature attained 98° C., the reactor was evacuated to <30 mbar and kept at this temperature for 2 hours with a soft nitrogen strip. The reactor was depressurized with nitrogen and cooled down to <60° C.

When the water content (EN 13267) of the product mixture was <0.2%, the material was filtered via a pressurized filter funnel at 60° C. and a pressure between 0-1 using the filter DSP-60-ML-17.

Analytical Values:

| Property | Value | |
|---|---|---|
| OH value | 64.7 | mg KOH/g |
| Colour iodine | 6.9 | |
| pH value (EN 1262, solution B) | 6.0 | |
| Water content | 0.02% | |
| Cloudpoint EN 1890, method A (1% in water) | 24-28° | C. |
| Cloudpoint EN 1890, method E (1% in BDG) | 84° | C. |
| Surface tension EN 14370 (1 g/l, 23° C.) | 33.6 | mN/m |
| Cloudpoint EN 1890, method A (1% in water) | 24-28° | C. |

### Example 2: Propoxylated Tocopherol (Tocopherol+10 PO, Desalted)

Compound of example 2 was prepared according to the process of example 1 with the quantity of components as follows:

| Component | Amount (g) |
|---|---|
| D,L-α-Tocopherol | 344.8 |
| potassium hydroxide 45% | 2.7 |
| Propylene oxide | 464.6 |
| water | 18 |
| Disodium dihydrogen pyrophosphate | 6.2 |

Analytical Values:

| Property | Value |
|---|---|
| OH value | 57.5 mg KOH/g |
| pH value (EN 1262, solution B) | 6.3 |
| Water content | 0.02% |

### Example 3: A Process for Preparing Ethoxylated Tocopherol (Tocopherol+25 EO, Desalted)

Compound of example 3 was prepared according to the process of example 1 with the amount of components as follows:

| Component | Amount (g) |
|---|---|
| D,L-α-Tocopherol | 514.0 |
| potassium hydroxide 45% | 6.2 |
| Ethylene oxide | 1314.2 |
| water | 18 |
| Disodium dihydrogen pyrophosphate | 14.1 |

Analytical Values:

| Property | Value |
|---|---|
| OH value | 36.8 mg KOH/g |
| Colour apha | 943 |
| pH value (EN 1262, solution B) | 7.2 |
| Water content | 0.02% |

### Example 4: A Process for Preparing Ethoxylated Tocopherol (Tocopherol+25 EO, Neutralized with Acetic Acid)

Equipment: 5 L Stainless steel reactors with cross-blade agitator, approved for at least 20 bara and vacuum. Controlled addition of all starting components through mass flow meters, Controlled addition of potassium hydroxide solution and acetic acid. Connections for water and nitrogen.

D,L-α-Tocopherol (1150.0 g) and potassium hydroxide solution 44% (13.9 g) were charged into the reactor. The reactor was heated to 120° C. and evacuated to <20 mbar for at least 30 minutes before it was aerated with nitrogen to 3 bar. The temperature of the reactor was increased to 140° C. Ethylene oxide (2938.4 g) was dosed at a temperature above 124° C. At a pressure of 5.4 bar the ethylene oxide dosing was paused and a consecutive reaction for 20 minutes (at reaction temperature) took place. Then the pressure was released until a pressure of 2 bar was reached and the EO dosing was continued. After the ethylene oxide dosing was finished a consecutive reaction for 30 minutes (at reaction temperature) took place. The reactor was cooled down to 100° C., depressurized and stripped at 1.5 bar for 30 minutes with nitrogen to obtain a product mixture containing ethoxylated tocopherol. Further, the product mixture containing ethoxylated tocopherol was neutralized by adding acetic acid (6.7 g).

The water content (EN 13267) of the product was <0.2%.

Analytical Values:

| Property | Value |
|---|---|
| OH value | 38.7 mg KOH/g |
| pH value (EN 1262, solution B) | 6.6 |
| Water content | 0.02% |

Surfactant Properties

The samples of the surfactants prepared in examples 3 and 4 of the presently claimed invention were analyzed for surfactant properties and the data obtained was compared with octylphenol ethoxylate (25EO), and the same data is tabulated hereinbelow in table 1.

TABLE 1

| | Octylphenol | Compound | Compound |
|---|---|---|---|
| | ethoxylate | of | of |
| | (25 EO) | example 3 | example 4 |
| Cloud point | 88.8 | 88.5 | 87.5 |
| (EN 1890, method B) ° C. | | | |
| Cloud point | 75.2 | 74 | 73.5 |
| (EN 1890, method C) ° C. | | | |
| Cloud point | 91.5 | 92 | 92 |
| (EN 1890, method D) ° C. | | | |
| Cloud point | 92 | 94 | 93.5 |
| (EN 1890, method E) ° C. | | | |
| pH | 5.9 | 6.8 | 6.2 |
| (EN 1262, solution B) | | | |
| Surface tension | 38.7 | 39.6 | 39.5 |
| (EN 14370, 1 g/l, 23° C.) | | | |
| mN/m | | | |
| Dynamic surface tension | 483/ | — | 64.0/ |
| (1 g/l in mN/m) | 448/428 | | 62.2/60.8 |
| ca. 0.03 s/1 s/10 s | | | |
| CMC (g/l) | 0.95 | — | 0.25 |

From Table 1, it is evident that the surfactant properties of the ethoxylated tocopherol of the present application is comparable to octylphenol ethoxylate (25EO).

### Example 5 (Tocopherol+25 EO Sulfate via Chlor Sulfonic Acid)

Sulfation: 493.7 g Tocopherol+25 EO (OH number 38.2 mg KOH/g) prepared according to example 3 are charged into a dry 2 L 4-neck round bottom flask, flushed with nitrogen and heated to 50° C. where the starting material is liquid. During the reaction the flask is continuously flushed with nitrogen. Chlorsulfonic Acid 99% (44.20 g) is added slowly over 2.5 hours while flushing with nitrogen. During the addition the temperature must not exceed 60° C. After completing the addition, the reaction mixture is kept at 56° C. for 2 hours under stirring and nitrogen flushing for post reaction. Afterward the mixture is cooled to <15° C.

Neutralization: A 4 L 4-neck flask is prepared and charged with 858.0 g of water and 24.6 g of NaOH (50%). 465.0 g of the sulphated product of above is charged into an addition funnel and added slowly to the NaOH/water mixture. The temperature is controlled to 35° C. by cooling. After adding about half the amount, additional water is charged into the flask and the temperature is raised to 65° C. to keep the reaction mixture fluid. At the end, 1.8 g phosphoric acid (85%) are added as buffer. A dark brown product is obtained that is gel-like at room temperature and liquid above 65° C.

Analytical Values:

| Property | Value |
|---|---|
| Dry matter | 24.43% |
| Active matter | 17.47% |
| NaCl | 0.017% |
| pH Value | 7.2 |

### Example 6: Sulfated Ethoxylated Tocopherol (Tocopherol+25 EO via SO₃)

The following example shall not limit the manufacturing process and process conditions. The sulfation of Tocopherol+25EO ethoxylate was done on a state-of-the-art continuous falling film sulfonation reactor at a temperature of 60° C. with a molar ratio of SO₃/α-Tocopherol+25EO=1.1-1.0 with dry air/SO₃ containing 5 vol % of SO₃. The product was neutralized after degassing with a mixture of caustic soda (50%) and water, calculated to obtain a concentration of approximately 20% anion active solution at a temperature of 50-70° C. keeping the pH-value in the range of 10-12 to avoid hydrolysis of the product.

655.2 g (0.427 mol) of α-Tocopherol+25EO were sulfated with 0.45 mol SO₃ diluted with dry air (550 l/h) within one hour on a falling film reactor at 60° C. The acidic ester was neutralized after degassing by adding it to a stirred solution of 46 g of 50% NaOH in 2750 ml of water at 50-70° C. The final product was analyzed by Epton titration for the content of anionic-active material, which was found to be 19.5% (molecular weight=1634).

The samples of the sulfated ethoxylated tocopherol prepared in example 6 of the presently claimed invention was analyzed for surfactant properties and the data obtained was compared with octylphenol ethoxylate sulfate (25EO), and the same data is tabulated hereinbelow in table 2.

TABLE 2

| | | | Octylphenol | |
|---|---|---|---|---|
| | | | ethoxylate | Compound |
| | | | sulfate | of |
| characteristic | method | unit | (25EO) | Example 6 |
| sodium sulfate | DGF H-III | % | 0.42 | 0.29 |
| | 8A | | | |
| water | | % | — | 78.1 |
| Dry residue (TR) | | % | 39.9 | 22.40 |
| Dry residue minus | | % | 36.5 | 22.11 |
| sulfate (TR-S) | | | | |
| SO₄ | | % | — | 0.20 |
| anionic surfactant | ISO 2271 | % | — | 19.45 |
| before hydrolysis | (MW 1634)* | | | |
| anionic surfactant | ISO 2271 | % | 2.79 | 1.21 |
| before hydrolysis | (MW 102)* | | | |
| (Epton) | | | | |
| Unsulfated Matter | | % | 1.7 | 2.54 |
| Surface tension | (EN 14370, | mN/m | 39.7 | 48.2 |
| | 1 g/l, 23° C.) | | | |
| Dynamic surface | (1 g/l in ca. | mN/m | 58.2/ | 71.9/ |
| tension | 0.03 s/1 s/10 | | 56.2/53.4 | 69.8/65.7 |
| | s) | | | |
| CMC | | g/l) | 0.94 | 0.045 |

From Table 2, it is evident that the surfactant properties of the sulfated ethoxylated tocopherol of the present application is very comparable to octylphenol ethoxylate sulfate (25EO).

### Example 7: Emulsion Polymerization of a Styrene/Acrylic Resin with Compound of Example 6

Equipment:

1.7 litre reaction vessel equipped with anchor stirrer (stirring speed 100 rpm) which was submersed into a water bath for temperature control, and feeding vessels (stirred for the monomer premix, non-stirred for the initiator feed) which were attached to weight modules for precise control of feeding.

Preparation of Comonomer-Premix:

Styrene, n-butyl acrylate, methacrylic acid, demineralized water, and the sulfated ethoxylated tocopherol of example 6 were mixed to yield the comonomer premix which was filled into the stirred feed vessel.

Preparation of Initiator Solution:

Sodium metabisulfite was dissolved in demineralized water to give the initiator solution which is filled into a non-stirred feed vessel.

Reaction Procedure:

The reaction vessel was precharged with a solution of potassium persulfate in demineralized water. Then, 225 g of the comonomer premix were added and temperature was raised to 60° C. At 60° C., 8 g of the initiator solution were added into the reaction vessel. After 5 min. the feeding of the comonomer premix and the initiator solution was started simultaneously. The comonomer premix was fed over a period of 150 minutes, the initiator solution over a period of 160 minutes. After the initiator solution had been fed completely, the temperature was raised to 65° C. and the mixture was stirred for another hour. The obtained dispersion was cooled to room temperature. The pH value was adjusted to 7-8 with aqueous ammonia solution (25% by weight).

Work-Up and Analysis:

The above dispersion was filtered over a 125 μm filter. The filter residue was rinsed with water, dried and weighed to give the coagulum content.

The quantities of the reactants mentioned in example 7 are given in table 3.

TABLE 3

| | | Example 7 A | Example 7 B |
|---|---|---|---|
| | | (inventive) | (comparative) |
| | Reactants | [in g] | [in g] |
| Reactor | Potassium persulfate | 4.00 | 4.00 |
| precharge | DI water | 250.00 | 250.00 |
| Feed 1 | Styrene | 400.00 | 400.00 |
| Preemulsion | Butyl acrylate | 400.00 | 400.00 |
| | Methacrylic acid | 15.00 | 15.00 |
| | Emulsifier, compound of | 20.00 | — |
| | example 6 (active matter) | | |
| | Octylphenol + 25 EO | — | 20.00 |
| | sulfate, Na-salt | | |
| | (active matter) | | |
| | DI water | 450.00 | 450.00 |
| Feed 2 | Sodium metabisulfite | 4.00 | 4.00 |
| Initiator | DI water | 100.00 | 100.00 |

The styrene/acrylic dispersions prepared in example 7A and 7B were analyzed. The analytical data is specified in table 4.

TABLE 4

| | Dispersion from | Dispersion from |
|---|---|---|
| | Example 7A | Example 7B |
| | Surfactant used: | |
| | Compound of | Octylphenol + 25 EO |
| | example 6 | sulfate, Na salt |
| Solid content [%] | 50.63 | 50.84 |
| Viscosity [mPas] | 98 | 197 |
| Conversion [%] | 99 | 99 |
| Coagulum [%] | 0.19 | 0.07 |
| Particle Size [nm] | 193 | 146 |
| Visual evaluation [scale 1-6] | 2 | 2 |
| Water absorption [%] | 5.1 | 2.5 |
| Electrolyte stability | 1% Al₂(SO₄)₃ | 1% Al₂(SO₄)₃ |
| Shear stability | Stable | Unstable after 15 min |
| Freeze/Thaw stability | −5° C. | −5° C. |

From table 4 it can be seen that a stable styrene/acrylic polymer can be prepared by using an anionic surfactant of the presently claimed invention as an emulsifier. The shear stability is improved compared to that of the comparative example.

### Example 8: Emulsion Polymerization of a Styrene/Acrylic Resin with Inventive Compounds of Example 4 and 6

Equipment:

1.7 litre reaction vessel equipped with anchor stirrer (stirring speed 100 rpm) which was submersed into a water bath for temperature control, and feeding vessels (stirred for the monomer premix, non-stirred for the initiator feed) which were attached to weight modules for precise control of feeding.

Reaction Procedure:

The reaction vessel was precharged with a solution of sodium persulfate in demineralized water and heated to 60° C. Then, 19 g of the comonomer premix were added and temperature was raised to 85° C. After 5 min. at 85° C. the feeding of the comonomer premix and the initiator solution was started simultaneously. The comonomer premix was fed over a period of 120 minutes, the initiator solution over a period of 150 minutes. After the initiator solution had been fed completely, the mixture was stirred for another hour. The obtained dispersion was cooled to room temperature. The pH value was adjusted to 9 with aqueous ammonia solution (25% by weight).

Work-Up and Analysis:

The above dispersion was filtered over a 125 μm filter. The filter residue was rinsed with water, dried and weighed to give the coagulum content.

The quantities of the reactants mentioned in example 8 are given in table 5.

TABLE 5

| | | Example 8 A | Example 8 B |
|---|---|---|---|
| | | (inventive) | (comparative) |
| | | Quantities | Quantities |
| | Reactants | [in g] | [in g] |
| Reactor | Sodium persulfate | 0.44 | 0.44 |
| precharge | DI water | 461.30 | 461.30 |
| Feed 1 | Styrene | 308.70 | 308.70 |
| Preemulsion | Butyl acrylate | 308.70 | 308.70 |
| | Methacrylic acid | 12.60 | 12.60 |
| | Emulsifier, compound of | 11.97 | — |
| | example 6 (active matter) | | |
| | Emulsifier, compound of | 6.30 | — |
| | example 4 (active matter) | | |
| | Octylphenol + 25 EO | — | 11.97 |
| | sulfate, Na-salt | | |
| | (active matter) | | |
| | Octylphenol + 25 EO | — | 6.30 |
| | (active matter) | | |
| | DI water | 210.00 | 210.00 |
| Feed 2 | Sodium metabisulfite | 1.01 | 1.01 |
| Initiator | DI water | 84.00 | 84.00 |

The styrene/acrylic dispersions prepared in example 8A and 8B were analyzed. The analytical data can be seen in table 6.

TABLE 6

| | Dispersion from | Dispersion from |
|---|---|---|
| | Example 8A | Example 8B |
| | Surfactant used: | |
| | Compound of | |
| | example 4 | Octylphenol + 25 EO |
| | Compound of | Octylphenol + 25 EO |
| | example 6 | Sulfate |
| Solid content [%] | 44.24 | 42.00 |
| Viscosity [mPas] | 358 | 30 |
| Conversion [%] | 96 | 91 |
| Coagulum [%] | 0.65 | 0.02 |
| Particle Size [nm] | 115 | 230 |
| Visual evaluation [1-6] | 2 | 2 |
| Water absorption [%] | 2.13 | 3.70 |
| Electrolyte stability | 1% Al₂(SO₄)₃ | 10% Al₂(SO₄)₃ |
| Shear stability | Unstable after 5 min | Stable |
| Freeze/Thaw Stability | −5° C. | −20° C. |
| [° C.] | | |

From table 6 it can be seen that a stable styrene/acrylic polymer can be prepared by using an anionic/nonionic surfactant combination (compound of example 4 and 6) of the presently claimed invention as emulsifier system.

1. (canceled)

2. (canceled)

3. (canceled)

4. A method of emulsion polymerization comprising:
(A) charging into a reactor a reaction mixture comprising:
(i) at least one monomer having an ethylenically unsaturated double bond,
(ii) at least one compound of general formula (I), 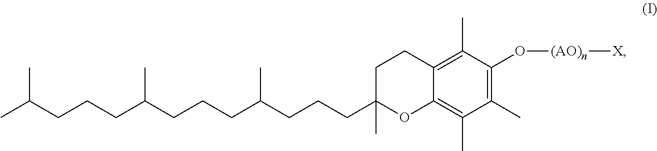
wherein
AO is identical or different and selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O,
n is an integer in a range from ≥1 to ≤100,
X is selected from H, SO₃M, PO₃HK, and PO₃M₂,
M is selected from H, alkali metal, ammonium, and alkanolamine cation; and
(iii) at least one polymerization initiator;
(B) maintaining the reaction mixture of step (A) in the reactor at a temperature in a range of ≥20° C. to ≤105° C. for a time period in a range of ≥30 minutes to ≤12 hours.

5. The method according to claim 4, wherein AO is identical or different and selected from the group consisting of CH₂—CH₂—O, CH(CH₃)—CH₂—O, and CH₂—CH(CH₃)—O.

6. The method according to claim 4, further comprising, as step (C), terminating the reaction mixture of step (B) with a terminating compound selected from the group consisting of sodium bisulfite and sodium metabisulfite.

7. The method according to claim 4, wherein the at least one monomer having an ethylenically unsaturated double bond is selected from the group consisting of acrylic monomers, vinyl aromatic hydrocarbons, and vinyl, allyl, and methallyl esters of saturated aliphatic C₂-C₂₄ monocarboxylic acids.

8. The method according to claim 4, wherein the polymerization initiator is an inorganic free radical initiator selected from the group consisting of ammonium persulfate, potassium persulfate, sodium persulfate, potassium peroxy dicarbonate, and potassium peroxy diphosphate.

9. A mixture comprising
(i) at least one monomer having an ethylenically unsaturated double bond selected from the group consisting of acrylic monomers, vinyl aromatic hydrocarbons, and vinyl, allyl and methallyl esters of saturated aliphatic C₂-C₂₄ monocarboxylic acids,
(ii) at least one compound of general formula (I) according to claim 4, and
(iii) water.

10. A mixture comprising
(i) at least one compound of general formula (I) according claim 4,
(ii) a polymer P, comprising at least one monomer selected from the group consisting of acrylic monomers, vinyl aromatic hydrocarbons, and vinyl, allyl and methallyl esters of saturated aliphatic C₂-C₂₄ monocarboxylic acids, in polymerized form, and
(iii) water.

11. The mixture comprising according to claim 9, wherein the at least one monomer is selected from the group consisting of acrylic acid, methacrylic acid, methyl (meth)acrylate, butyl(meth)acrylate, n-butyl acrylate, styrene, vinyltoluene, tert-butylstyrene, α-methylstyrene, vinyl acetate, vinyl propionate, vinyl butyrate, vinyl pivalate, vinyl hexanoate, vinyl-2-ethylhexanoate, vinyl laurate, and vinyl stearate.

12. A compound of general formula (Ia) 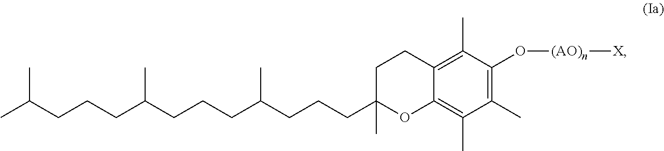
wherein
AO is CH₂—CH₂—O,
n is an integer in [[the]] a range from ≥0 to ≤100,
X is selected from SO₃M, PO₃HM, and PO₃M₂, and
M is selected from H, alkali metal, ammonium., and alkanolamine cation.

13. The compound of general formula (Ia) according to claim 12, wherein n is an integer in the range of 1 to 100.

14. A compound of general formula (Ib) 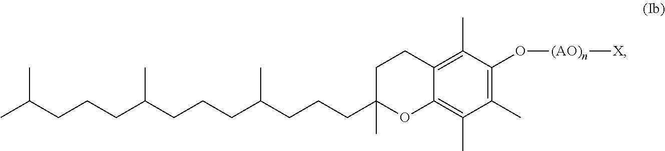
wherein
AO is identical or different and selected from the group consisting of CH(CH₃)—CH₂O, CH₂—CH(CH₃)—O, CH(C₂H₅)—CH₂—O, C(CH₃)₂—CH₂—O, CH₂C(CH₃)₂—O, and CH₂—CH(C₂H₅)—O,
n is an integer in a range from ≥1 to ≤100,
X is selected from H, SO₃M, PO₃HM, and PO₃M₂, and
M is selected from H, alkali metal, ammonium, and alkanolamine cation.

15. A mixture comprising
(a1) at least one compound of general formula (Ia); and
(a2) at least one compound of general formula (Ib).

16. A cleaning composition comprising
(I) at least one compound of general formula (I) as defined in claim 4; and
(II) at least one additive selected from the group consisting of solvents, surfactants, amine oxides, curing agents, dyes, fragrances, antimicrobial agents, thickening agents, anti-redeposition agents, and fatty alcohols.

17. The cleaning composition according to claim 16 which is in solid or liquid form.

18. (canceled)

19. A process for preparation of a compound as defined in claim 4, comprising
a. alkoxylation of a compound of formula (II) with an alkoxylating agent, 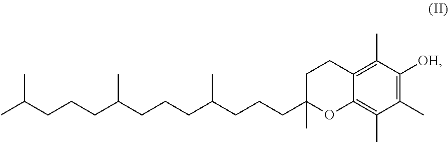 [SMILES: Cc1c(C)c2c(c(C)c1O)CCC(C)(CCCC(C)CCCC(C)CCCC(C)C)O2]
to obtain an alkoxylated product, and
b. sulfation of the alkoxylated product obtained in step a. with a sulfating agent.

20. The process according to claim 19, further comprising, as step c., treating with an alkali metal hydroxide.

21. The process according to claim 19, further comprising phosphating the alkoxylated product obtained in step a. with a phosphating agent.

22. The process according to claim 19, wherein the alkoxylating agent is selected from the group consisting of ethylene oxide, propylene oxide, and mixtures thereof.

23. The process according to claim 19, wherein the sulfating agent is selected from the group consisting of chlorosulfonic acid and sulfur trioxide.

24. The process according to claim 21, wherein the phosphating agent is selected from the group consisting of phosphoric acid, phosphorus pentoxide (P₂O₅), tetraphosphoric acid, and salts thereof.

25. The process according to claim 19, wherein step a. is carried out at a temperature in a range of ≥50° C. to ≤160° C. for a time period in a range of ≥1 hour to ≤10 hours.

26. The process according to claim 19, wherein step b. is carried out at a temperature in a range of ≥40° C. to ≤80° C. for a time period in a range of ≥15 minutes to ≤3 hours.

27. The process according to claim 19, wherein a molar ratio of the compound of formula (II) to the alkoxylating agent is in a range from 1:5 to 1:50.

28. The process according to claim 19, wherein a molar ratio of the alkoxylated product obtained in step a. to the sulfating agent is in a range from 0.5:1 to 1.5:2.
